(19) United States
(12) Patent Application Publication
(10) Pub. No.: US 2022/0404783 A1
(43) Pub. Date: Dec. 22, 2022

(54) INFORMATION PROCESSING APPARATUS, INFORMATION PROCESSING METHOD, AND INFORMATION PROCESSING PROGRAM

(71) Applicant: SONY GROUP CORPORATION, TOKYO (JP)

(72) Inventors: YOUSUKE KAWANA, TOKYO (JP); FUMIHIKO IIDA, TOKYO (JP); KENTARO IDA, TOKYO (JP); TAKUMA SUZUKI, TOKYO (JP)

(21) Appl. No.: 17/755,676

(22) PCT Filed: Oct. 28, 2020
(86) PCT No.: PCT/JP2020/040430

§ 371 Date: May 5, 2022

(30) Foreign Application Priority Data
Nov. 14, 2019 (JP) 2019-206558

(51) Int. Cl. G05B 15/02

(52) U.S. Cl. CPC G05B 15/02; F24F 11/0001

(57) ABSTRACT

An information processing apparatus according to the present application includes an acquisition unit, a determination unit, and an appliance control unit. The acquisition unit acquires recipe information which is information regarding cooking performed by the user. Based on the recipe information acquired by the acquisition unit, the determination unit determines a non-cooking appliance that is an appliance used by the user and is not used for cooking to be an appliance being a control target. The appliance control unit controls the non-cooking appliance determined by the determination unit at a timing before a predetermined process based on a predetermined condition.

### FIELD

The present invention relates to an information processing apparatus, an information processing method, and an information processing program.

### BACKGROUND

In recent years, with the rise of multifunctional and diversified appliances in a living space, it has become easy for a user to independently establish and live in a comfortable environment. However, the life includes an event (task) that changes the comfortable environment of the user. A typical example of this is “cooking”.

When a user cooks in the kitchen, the user needs to concentrate on the work in front of the user. Therefore, places other than the kitchen are sometimes out of eyeshot, making it difficult to grasp a change in the surrounding situation. In another case where an interrupting task such as dealing with an unexpected guest, there is a possibility that the work needs to be temporarily stopped.

There is a known technique of changing a display of a heating status to be projected in accordance with a user emotion during cooking. In addition, there is another known technique of controlling the display of the heating status in real time.

### CITATION LIST

### Patent Literature

Patent Literature 1: WO 2018/066190 A

### SUMMARY

### Technical Problem

Although the known technique can give a sense of security and a sense of relaxation during cooking, there is room for improvement in the comfort to be personally felt by the user and the comfort in the entire living space.

The present application has been made in view of the above, and aims to promote improvement in comfort in a living environment of a user.

### Solution to Problem

An information processing apparatus according to the present disclosure includes: an acquisition unit that acquires recipe information, the recipe information being information regarding cooking performed by a user; a determination unit that determines a non-cooking appliance, the non-cooking appliance being an appliance used by the user and not used for cooking, to be an appliance being a control target based on the recipe information acquired by the acquisition unit; and an appliance control unit that controls the non-cooking appliance determined by the determination unit at a timing before a predetermined process based on a predetermined condition.

### BRIEF DESCRIPTION OF DRAWINGS

FIG. 1 is a diagram illustrating a configuration example of an information processing system according to an embodiment.

FIG. 2 is a diagram illustrating an example of determination (selection) of a recipe according to the embodiment.

FIG. 3 is a diagram illustrating an example of determination (viewing) of a recipe according to the embodiment.

FIG. 4 is a diagram illustrating an example of determination (menu) of a recipe according to the embodiment.

FIG. 5 is a diagram illustrating an example of a specific factor according to the embodiment.

FIG. 6 is a diagram illustrating an example of a cooking appliance and a non-cooking appliance according to the embodiment.

FIG. 7 is a diagram illustrating an example of specifications of the non-cooking appliance according to the embodiment.

FIG. 8 is a diagram illustrating an example of a heat control method according to the embodiment.

FIG. 9 is a diagram illustrating an example of a method of controlling wind or smell according to the embodiment.

FIG. 10 is a diagram illustrating an example of a sound control method according to the embodiment.

FIG. 11 is a diagram illustrating a configuration example of an information processing apparatus according to the embodiment.

FIG. 12 is a diagram illustrating an example of a recipe information storage unit according to the embodiment.

FIG. 13 is a diagram illustrating an example of the recipe information storage unit according to the embodiment.

FIG. 14 is a diagram illustrating an example of an appliance information storage unit according to the embodiment.

FIG. 15 is a diagram illustrating an example of a living space information storage unit according to the embodiment.

FIG. 16 is a flowchart illustrating an example of information processing according to the embodiment.

FIG. 17 is a diagram illustrating a configuration example (first modification) of an information processing system according to the embodiment.

FIG. 18 is a diagram illustrating a configuration example (second modification) of the information processing system according to the embodiment.

FIG. 19 is a diagram illustrating a configuration example (second modification) of the information processing system according to the embodiment.

FIG. 20 is a hardware configuration diagram illustrating an example of a computer that actualizes functions of an information processing apparatus.

### DESCRIPTION OF EMBODIMENTS

Hereinafter, modes (hereinafter referred to as “embodiments”) for implementing an information processing apparatus, an information processing method, and an information processing program according to the present application will be described in detail with reference to the drawings. Note that the information processing apparatus, the information processing method, and the information processing program according to the present application are not limited by the embodiments. In each of the following embodiments, the same parts are denoted by the same reference symbols, and a repetitive description thereof will be omitted.

The present disclosure will be described in the following order.

1. Configuration of information processing system

2. Example of Information processing

2.1. Determination of recipe

2.1.1. Determination of recipe based on user's intention

2.1.2. Determination of recipe in user's living activities

2.1.3. Determination of recipe preset by user

2.2. Specific factor

2.3. Method of controlling specific factor

2.3.1. Method of controlling heat

2.3.2. Method of controlling wind or smell

2.3.3. Method of controlling sound

2.3.4. Method of controlling cooking time

3. Variations of processing

3.1. User's comfortable living space setting 1

3.2. User's comfortable living space setting 2

3.3. Priority for suppressing influence of specific factor

3.4. Optimal method of selecting non-cooking appliance

3.5. Optimal method of selecting non-cooking appliance in consideration of external environment

3.6. Optimal method of selecting non-cooking appliance in consideration of user situation

3.7. Determination of timing related to cooking

3.7.1. Inputting timing by user with intention

3.7.2. Determination of timing based on user's action

3.8. Others

3.8.1. Living space according to embodiment

3.8.2. smell according to embodiment

3.8.3. Heat according to embodiment

3.8.4. Cooking according to embodiment

3.8.5. Cooking process according to embodiment

3.8.6. Recipes according to embodiment

3.8.7. Imaging information according to embodiment

3.8.8. specific factor according to embodiment

3.8.9. Selecting plurality of non-cooking appliances

3.8.10. “Listen” and “view” according to embodiment

3.8.11. Timing before predetermined process according to embodiment 3.8.12. Determination of user's interest using biometric information of user

3.8.13. Method for displaying specification of non-cooking appliance

3.8.14. Estimation processing based on recipe information

3.8.15. Method of calculating distance from cooking appliance

4. Configuration of information processing apparatus

5. Flow of information processing

6. Modification

6.1. Utilization of information providing device

6.2. Utilization of projection device

6.3. First modification of information processing system

6.4. Second modification of information processing system

7. Hardware configuration

8. Others

### EMBODIMENTS

### 1. Configuration of Information Processing System

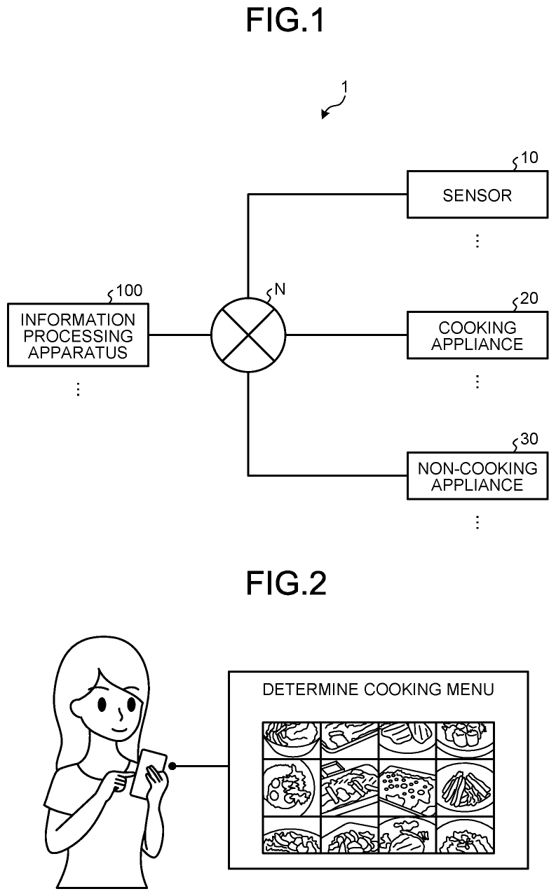

A configuration of an information processing system 1 will be described with reference to FIG. 1. FIG. 1 is a diagram illustrating a configuration example of an information processing system according to an embodiment. As illustrated in FIG. 1, the information processing system 1 includes a sensor 10, a cooking appliance 20, a non-cooking appliance 30, and an information processing apparatus 100. The sensor 10, the cooking appliance 20, the non-cooking appliance 30, and the information processing apparatus 100 are communicably connected by wired or wireless connection via a predetermined communication network (network N). FIG. 1 is a diagram illustrating a configuration example of an information processing system according to an embodiment. The information processing system 1 illustrated in FIG. 1 may include a plurality of sensors 10, a plurality of cooking appliances 20, a plurality of non-cooking appliances 30, and a plurality of information processing apparatuses 100.

The sensor 10 may be any sensor capable of implementing the processing according to the embodiment. The sensor 10 is used to provide information regarding the user, information regarding the living space of the user, and the like to the information processing apparatus 100. For example, the sensor 10 may be a sensor that recognizes different types of information. Hereinafter, the sensor 10 that recognizes three different types of information will be described as an example.

The sensor 10 may be a sensor that recognizes an environment of the living space. For example, the sensor 10 may be a sensor that recognizes an appliance present in the living space and grasps an arrangement or the like of the appliance. In this case, the sensor 10 may be a sensor using LiDAR as a means for recognizing the environment of the living space. Here, LiDAR is one of remote sensing technologies using light beams, and is a technology that measures scattered light based on emitted laser beams in the form of pulsed light and analyzes a distance to a distant object or a property of the object. Furthermore, the sensor 10 may be provided as a device such as a web camera or the like that can recognize the environment of the living space.

The sensor 10 may be a sensor that recognizes user information in the living space. For example, the sensor 10 may be a sensor that recognizes the presence or absence, the number, the position, the posture, the face orientation, fingers, gestures, etc. regarding the user in the living space. For example, the sensor 10 may be a sensor that specifies an individual user. In this case, the sensor 10 may be a sensor using OptiTrack or SoftKinetic as a means that recognizes information such as movement of the user in the living space. Here, the OptiTrack is one of motion capture systems used in a wide range of fields such as motion analysis, industrial analysis, non-contact sensing, and system control. On the other hand, SoftKinetic is one of sensing systems including a ranging image sensor technology in which a distance to an object is measured using an image sensor. Furthermore, the sensor 10 may be an infrared camera, a high-resolution depth sensor, or the like that can recognize fine movement of the user's fingers.

The sensor 10 may be a sensor that recognizes an input by a user. For example, the sensor 10 may be a sensor that recognizes an operation when the user determines a cooking recipe which is a recipe related to cooking (hereinafter, appropriately referred to as a “recipe”), contents input by the user, and the like. In this case, the sensor 10 may be a smartphone, a tablet, a voice input device, and the like, which is an operation target when determining a recipe.

The cooking appliance 20 may be any appliance as long as it is an appliance used by the user for cooking. Hereinafter, the appliance used for cooking by the user is appropriately referred to as a “cooking appliance”. Note that the appliance used when the user cooks may be appropriately referred to as a “cooking appliance”. For example, the cooking appliance 20 may be an appliance that is used when the user cooks, and may be an appliance that is not directly used by the user for cooking. This may include, for example, a ventilator, or the like. For example, the cooking appliance 20 is an appliance installed around a kitchen. Specific examples of the cooking appliance 20 include a gas stove, an electric stove, a ventilator, a rice cooker, a microwave oven, an oven, an electric pot, and a refrigerator.

The non-cooking appliance 30 may be any appliance as long as the appliance is not used by the user for cooking. Hereinafter, appliances that are not used for cooking by the user are appropriately referred to as “non-cooking appliances”. Note that appliances that are not used when the user cooks may be appropriately referred to as “non-cooking appliances”. For example, the non-cooking appliance 30 is an appliance closely related to the user's life. Specific examples of the non-cooking appliance 30 include a television, an air conditioner, a washing machine, a laundry dryer, an electric fan, a vacuum cleaner, a light, a window (for example, the electric window), a heater, and a hairdryer.

The information processing apparatus 100 is used to control the non-cooking appliance 30. The information processing apparatus 100 is, for example, an information processing apparatus such as a PC or a WS, and performs processing based on information transmitted from the sensor 10 or the like via the network N.

### 2. Example of Information Processing

The following will describe processing in which the information processing apparatus 100 estimates the influence on the living environment during cooking based on recipe information which is information regarding cooking performed by the user, and controls the non-cooking appliance based on the estimation result. The embodiment assumes that the control of the non-cooking appliance is performed before cooking. In addition, the predetermined process according to the embodiment may also include a process in which the user takes a meal. Hereinafter, the cooking appliance and the non-cooking appliance may be collectively referred to as an “appliance”.

### 2-1. Determination of Recipe

Hereinafter, processing in which the information processing apparatus 100 determines a recipe for cooking performed by the user will be described. For example, the information processing apparatus 100 determines a recipe for the cooking performed by the user based on any of the following three cases. Furthermore, the information processing apparatus 100 acquires recipe information corresponding to the determined recipe.

[2-1-1. Determination of Recipe Based on User's Intention]

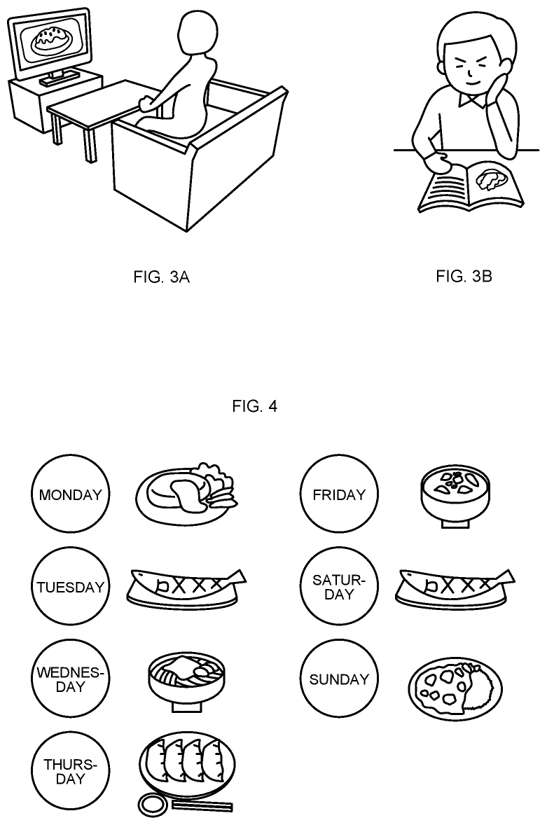

FIG. 2 illustrates a case where the user selects a recipe based on the user' intention. As illustrated in FIG. 2, there may be a case where the user selects a recipe based on the user's intention, such as a case where a recipe that the user desires to use for cooking is determined in advance. In this case, the information processing apparatus 100 acquires recipe information regarding a recipe selected based on user's operation (for example, a tap, a click, or the like). For example, the information processing apparatus 100 acquires recipe information regarding a recipe selected based on an operation on a user interface (UI) screen of a user's smartphone or the like. Although FIG. 2 illustrates a case where the user operates the UI screen of the smartphone, the UI screen is not limited to the smartphone and may be a UI screen on any type of object. FIG. 2 illustrates a case where a recipe is selected based on an operation on the UI screen. However, the method is not limited to the operation on the UI screen, and any method may be used as long the method is usable for the user to select a recipe. For example, the information processing apparatus 100 may acquire the recipe information regarding the recipe selected via a voice agent such as Siri (registered trademark) or Google Home (registered trademark).

Furthermore, for example, in a case where a recipe desired to be used for cooking by the user is not determined in advance, it is conceivable that the user browses the recipe on a smartphone or the like but does not intentionally select the recipe. In this case, the information processing apparatus 100 estimates a recipe that the user desires to use for cooking based on recipe browsing times, which is the number of times of browsing of the recipe by the user, and acquires recipe information regarding the estimated recipe. Note that the information processing apparatus 100 may perform estimation using not only the number of times of browsing of the recipe but also any information by which the recipe the user desires to use for cooking can be estimated. For example, the information processing apparatus 100 may estimate a recipe that the user desires to use for cooking based on the browsing frequency of the recipe. For example, the information processing apparatus 100 may estimate a recipe that the user desires to use for cooking based on a browsing frequency of the recipe in a predetermined period.

[2-1-2. Determination of Recipe in User's Living Activities]

FIG. 3 illustrates a case where the information processing apparatus 100 determines a recipe from the user's living activities. Here, the living activities of the user are activities that the user routinely performs in his/her life. FIG. 3(a) illustrates a case where the user is watching television as an example of the living activities of the user. FIG. 3(b) illustrates a case where the user is browsing through a magazine as an example of the living activities of the user. In this case, the information processing apparatus 100 estimates a recipe that the user desires to use for cooking based on a gaze time during which the user is gazing, and acquires recipe information regarding the estimated recipe. Specifically, the information processing apparatus 100 estimates a recipe that the user desires to use for cooking based on a gaze time of the user for imaging information (for example, a video, an image, or the like) regarding cooking. Here, the imaging information may be a still image or a moving image. More specifically, in a case where the gaze time of the user for the imaging information regarding cooking is a predetermined threshold or more, the information processing apparatus 100 may estimate a recipe as a target of the corresponding imaging information as a recipe that the user desires to use for cooking. Note that the information processing apparatus 100 may perform estimation using not only the gaze time of the user but also any type of user information related to imaging information. For example, the information processing apparatus 100 may estimate a recipe being a target of imaging information for which the diameter of the pupil of the user is a predetermined threshold or more as a recipe desired to be used for cooking by the user based on the dilation and constriction of the pupil of the user for the imaging information.

[2-1-3. Determination of Recipe Preset by User]

FIG. 4 illustrates a case where the user has set a menu in advance. As illustrated in FIG. 4, it is conceivable that a menu is already determined for each day of the week. An example of this case is school lunch. In this case, the information processing apparatus 100 acquires recipe information that is, information regarding a recipe corresponding to a preset menu. Although FIG. 4 illustrates a case where the menu is determined for each day of the week, the cycle of the menu is not limited to each day of the week, and the menu may be determined in any cycle or period. Furthermore, it is assumed that the user may input a menu setting using any means. For example, it is assumed that the user may input menu setting through an operation on the UI screen or through a voice agent.

The processing in which the information processing apparatus 100 determines the recipe to be used for cooking by the user has been described as above. Furthermore, the above-described three cases are all examples, and the information processing apparatus 100 may use any method to determine the recipe to be used for cooking by the user.

### 2-2. Specific Factor

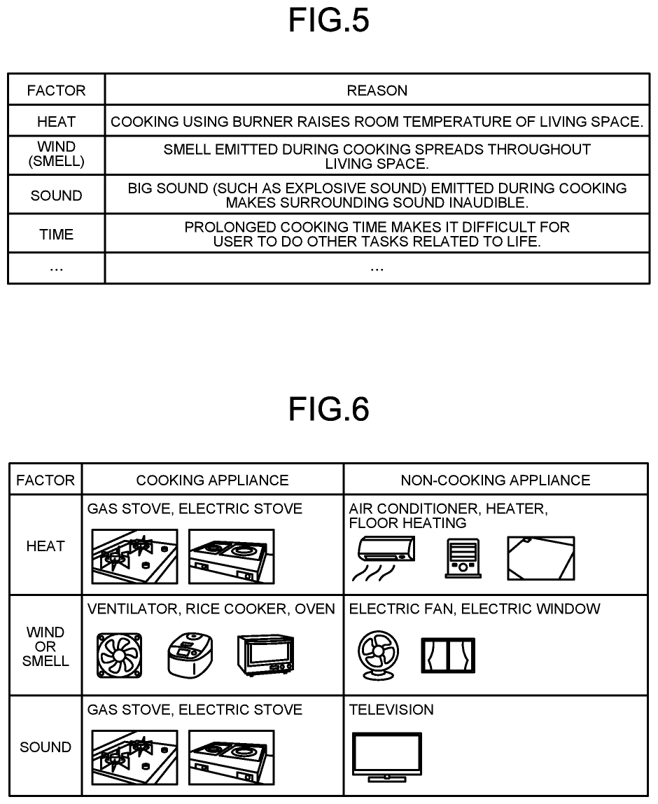

When the user performs cooking, there can be a factor (hereinafter, appropriately referred to as a “specific factor”) that impairs comfort of the living space. FIG. 5 illustrates an example of factors that impair the comfort of the living space. Specifically, factors that impair the comfort of the living space can include heat, wind, or smell (odor), sound, time, and the like. As illustrated in FIG. 5, the reason why heat can be a factor is that there is a possibility that cooking using burner or electricity can increase the temperature of the living space (for example, room temperature), for example. In addition, the reason why the wind or the smell can be a factor is that there is a possibility that the smell emitted during cooking spreads over the entire living space, for example. In addition, the reason why the sound can be a factor is that occurrence of a big sound (for example, explosive sound) emitted during cooking can lead to a situation having difficulty in hearing (listening to) the surrounding sound, for example. Furthermore, the reason why time can be a factor is that prolonged cooking time can lead to a situation in which the user has difficulty performing other tasks related to life (for example, cleaning, washing, and the like).

FIG. 6 illustrates an example of a cooking appliance that can be the source of specific factors. As illustrated in FIG. 6, cooking appliances having a possibility of emitting heat include a gas stove and an electric stove. Cooking appliances that can emit wind or smell include ventilators, rice cookers, ovens, and the like. In addition, cooking appliances that can emit sound include a gas stove and an electric stove. Note that a cooking appliance that can have a long cooking time differs depending on the type of cooking, and thus description thereof is omitted.

FIG. 6 illustrates an example of non-cooking appliances that can suppress the influence of occurrence of the specific factors. As illustrated in FIG. 6, examples of the non-cooking appliances that can suppress the influence of the generated heat include an air conditioner, a heater, and floor heating. In addition, examples of the non-cooking appliance that can suppress the influence of the generated wind or smell include an electric fan and an electric window. In addition, examples of the non-cooking appliance that can suppress the influence of the generated sound include a television. Note that description of non-cooking appliances that can shorten the cooking time is omitted.

In addition, as illustrated in FIG. 6, it is assumed that the cooking appliances and the non-cooking appliances are paired in advance for each specific factor. In other words, it is assumed that the non-cooking appliances are associated with the cooking appliances for each specific factor. By estimating a cooking appliance, the information processing apparatus 100 determines a non-cooking appliance associated with the estimated cooking appliance to be the non-cooking appliance being a control target.

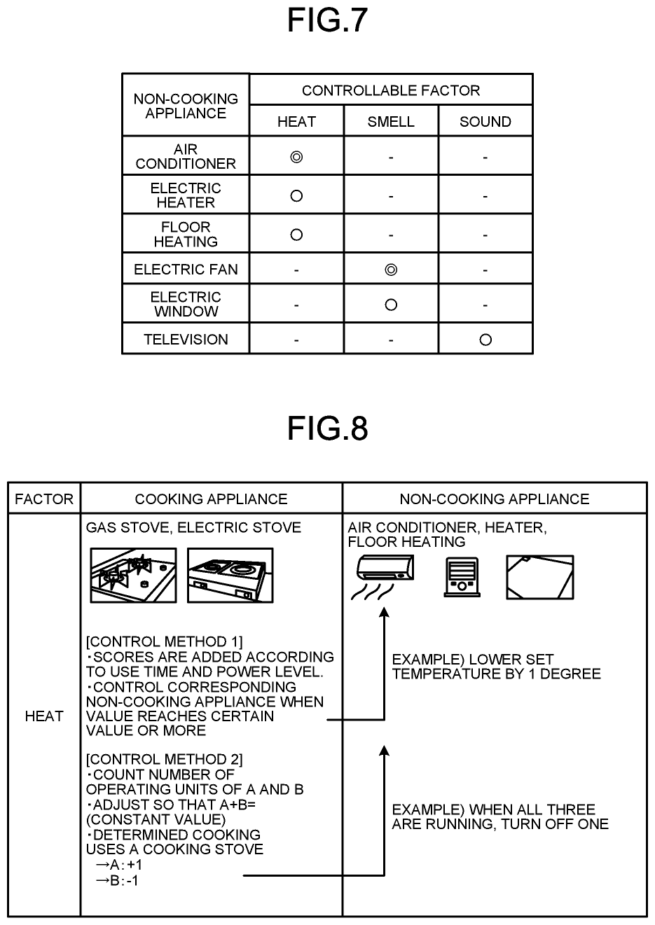

FIG. 7 illustrates an example of an effect of non-cooking appliances when suppressing the influence of specific factors using the non-cooking appliances. Here, the effect of the non-cooking appliance is the capability (specification) of the non-cooking appliance to suppress the influence of a specific factor. For example, when the non-cooking appliance has a high effect, it means that the non-cooking appliance has a high capability to suppress the influence of a specific factor. In addition, a non-cooking appliance having a high capability to suppress the influence of the specific factor can suppress the influence of a specific factor more quickly and efficiently, for example, compared with the non-cooking appliance having a low capability. For example, it is assumed that the non-cooking appliance having a high capability to suppress the influence of the specific factor can efficiently suppress the influence of the specific factor with less power consumption as compared with the non-cooking appliance having a low capability.

FIG. 7 illustrates an air conditioner, an electric heater, floor heating, an electric fan, an electric window, and a television as an example of the non-cooking appliance. FIG. 7 illustrates an effect on each of the specific factors. A single circle illustrated in FIG. 7 indicates that the effect of the non-cooking appliance on a specific factor is high. For example, the single circle illustrated in FIG. 7 may be a mark given when the effect of the non-cooking appliance on a specific factor is a predetermined threshold or more. In addition, the double circle illustrated in FIG. 7 indicates that the effect of the non-cooking appliance for a specific factor is extremely high. Specifically, the double circle illustrated in FIG. 7 indicates that the effect of the non-cooking appliance for a specific factor is more effective than the single circle. In addition, a bar line illustrated in FIG. 7 indicates that the effect of the non-cooking appliance on the specific factor is not high. For example, the bar line illustrated in FIG. 7 may be a mark given when the effect of the non-cooking appliance on a specific factor is less than a predetermined threshold.

The following will describe a case where the information processing apparatus 100 estimates information regarding cooking performed by the user based on the recipe information and performs information processing based on the estimation result. Hereinafter, a case where four different pieces of information are estimated as the information regarding cooking performed by the user will be described as an example.

The information processing apparatus 100 may perform information processing by estimating a cooking process related to cooking performed by the user based on the recipe information and estimating the occurrence of a specific factor based on the estimated cooking process. Specifically, in a case where the information processing apparatus has estimated cooking processes such as simmering and baking based on the recipe information, the information processing apparatus 100 may estimate that the temperature of the living space will rise. As another example, in a case where a cooking process such as cooling or using liquid nitrogen is estimated based on the recipe information, the information processing apparatus 100 may estimate that the temperature of the living space will drop.

Furthermore, the information processing apparatus 100 may perform information processing by estimating a substance generated in each cooking process based on the recipe information and estimating the occurrence of a specific factor based on the estimated substance. Specifically, the information processing apparatus 100 may estimate that an action such as adding garlic to a pot will lead to emission of a volatile substance contained in garlic and estimate spreading of a smell over the entire living space by the estimated volatile substance. As another example, the information processing apparatus 100 may estimate that an action such as burning the garlic will lead to a carbon substance produced from garlic and estimate that smoke will be generated and spread over the entire living space based on the estimated carbon substance. In this manner, when having estimated information regarding cooking that emits smell based on recipe information, the information processing apparatus 100 may estimate that the smell spreads over the entire living space.

Furthermore, the information processing apparatus 100 may estimate a cooking utensil related to the cooking performed by the user based on the recipe information, and may perform information processing by estimating occurrence of a specific factor based on the estimated cooking utensil. Specifically, when having estimated a heat generating cooking utensil such as a pot based on the recipe information, the information processing apparatus 100 may estimate that the temperature of the living space will rise. Specifically, when having estimated the use of the heat generating cooking utensil, such as heating oil in a pot, based on the recipe information, the information processing apparatus 100 may estimate that the temperature of the living space will rise.

Furthermore, the information processing apparatus 100 may estimate a cooking time related to the cooking performed by the user based on the recipe information, and may perform information processing by estimating occurrence of a specific factor based on the estimated cooking time. Specifically, when having estimated that the cooking time would be prolonged based on the recipe information, the information processing apparatus 100 may estimate that the user will have difficulty performing other tasks related to life.

### 2-3. Method of Controlling Specific Factor

Hereinafter, processing in which the information processing apparatus 100 controls the non-cooking appliance to suppress the influence of a specific factor occurring during cooking will be described. Hereinafter, the processing will be described for each specific factor.

[2-3-1. Method of Controlling Heat]

FIG. 8 illustrates an example in which the information processing apparatus 100 controls a non-cooking appliance in order to suppress the influence of heat generated during cooking. FIG. 8 illustrates a case where the information processing apparatus 100 estimates cooking processes such as simmering and baking based on the recipe information. Alternatively, a case is illustrated in which the information processing apparatus 100 estimates a cooking utensil that generates heat, such as a pot, based on the recipe information. FIG. 8 illustrates a case where the information processing apparatus 100 estimates cooking appliances such as a gas stove and an electric stove based on recipe information.

The information processing apparatus 100 estimates information regarding cooking using the cooking appliance. For example, the information processing apparatus 100 estimates parameters related to the cooking appliance, such as the use time and power level of the cooking appliance. Then, the information processing apparatus 100 calculates the score of the cooking appliance based on the parameter related to the cooking appliance. Specifically, the information processing apparatus 100 calculates a score indicating the degree of heat generated. Alternatively, the information processing apparatus 100 may calculate a score indicating the degree of influence of generated heat on the living space according to the capacity (for example, the dimensions, area, and the like) of the living space. Then, in a case where the calculated score satisfies a predetermined threshold or more, the information processing apparatus 100 estimates that the temperature of the living space will increase due to the generated heat. In this case, the information processing apparatus 100 determines to control the non-cooking appliance associated with the corresponding cooking appliance. For example, the information processing apparatus 100 determines to lower the set temperature of the air conditioner that is a non-cooking appliance.

The information processing apparatus 100 may determine to lower the set temperature of the air conditioner by a temperature equivalent to the temperature of the living space estimated to rise by the generated heat. As a specific example, when it is estimated that the temperature of the living space will rise by 1 degree due to the generated heat, the information processing apparatus 100 may determine to lower the set temperature of the air conditioner by one degree. Alternatively, the information processing apparatus 100 may determine to lower the set temperature of the air conditioner such that the temperature of the living space will lower by the temperature equivalent to the temperature estimated to rise due to the generated heat. As a specific example, in a case where it is estimated that the temperature of the living space will rise by two degrees due to the generated heat, and it is estimated that the temperature of the living space will be lowered by two degrees by lowering the set temperature of the air conditioner by one degree, the information processing apparatus 100 may determine to lower the set temperature of the air conditioner by one degree. This makes it possible for the information processing apparatus 100 to suppress a change in the temperature of the living space during cooking.

Furthermore, the information processing apparatus 100 may control the non-cooking appliance based on the information regarding the cooking appliance in the living space and the information regarding the non-cooking appliance associated with the corresponding cooking appliance. For example, the information processing apparatus 100 may control the non-cooking appliance based on the number of appliances used (the number of operating devices) in the living space. Here, the number of appliances used in the living space is the total number of appliances currently used in the living space, for example. For example, the information processing apparatus 100 may control the number of non-cooking appliances used. For example, the information processing apparatus 100 may control the non-cooking appliance by setting an upper limit value usable at the same time by the user in the number of appliances used for the cooking appliance and the non-cooking appliance. Here, the upper limit value may be set in any manner. For example, the upper limit value may be set in advance by the user. For example, the upper limit value may be set by the information processing apparatus 100 such that power consumption in the living space satisfies a predetermined condition. Note that the upper limit value may be set for each specific factor. For example, the upper limit value may be an upper limit value based on a cooking appliance having a possibility of emitting heat and a non-cooking appliance associated with the cooking appliance that can generate heat. In other words, the upper limit value may be an upper limit value based on the cooking appliance having a possibility of emitting heat and the non-cooking appliance that can suppress the influence of the generated heat. In this case, in a case where the number of appliances used between the cooking appliance and the non-cooking appliance exceeds the upper limit value according to the estimated cooking appliance, the information processing apparatus 100 may determine to stop the operation of the non-cooking appliances as many as those exceeding the upper limit value. For example, the information processing apparatus 100 may determine to stop the operation preferentially from the non-cooking appliance having the lowest efficiency regarding power consumption as the efficiency of suppressing the influence of the generated heat. For example, the information processing apparatus 100 may determine to stop the operation preferentially from the non-cooking appliance having the lowest priority based on the information regarding the external environment, the user's situation, the user's preference, and the like.

[2-3-2. Method of Controlling Wind or Smell]

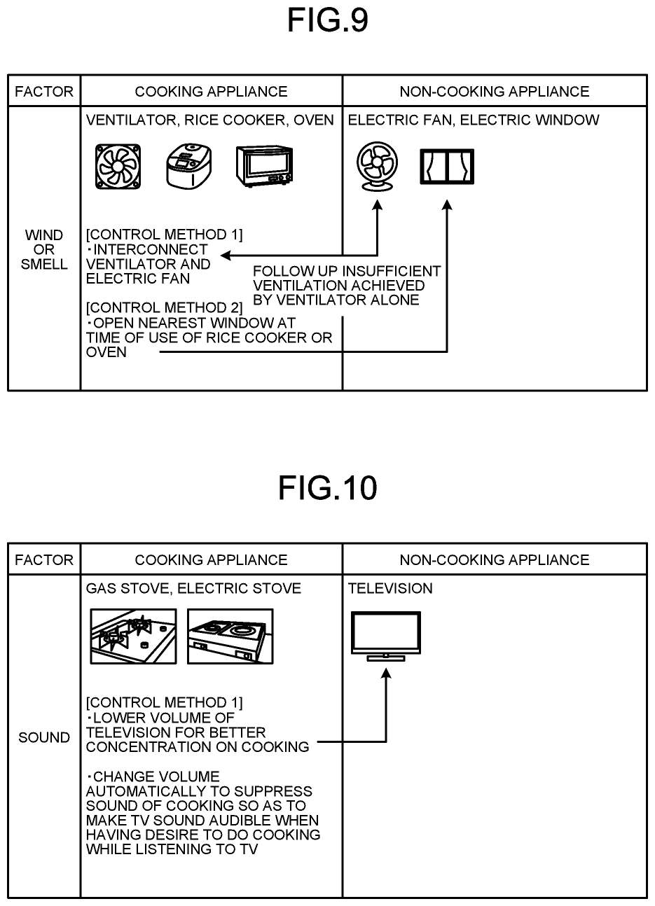

FIG. 9 illustrates an example in which the information processing apparatus 100 controls the non-cooking appliance in order to suppress the influence of wind or smell generated during cooking. FIG. 9 illustrates a case where the information processing apparatus 100 estimates information regarding cooking that emits smell based on recipe information. FIG. 9 illustrates a case where the information processing apparatus 100 estimates cooking appliances such as a ventilator, a rice cooker, and an oven based on recipe information. Hereinafter, description of processing similar to the heat control method will be appropriately omitted.

Even though the user is estimated to use a cooking appliance such as a ventilator during cooking, when the degree of smell related to cooking is large, sufficient ventilation cannot be obtained only by ventilation using a ventilator, leading to a possible situation in which the smell spreads throughout the living space. In this situation, by operating an electric fan which is a non-cooking appliance to increase the ventilation volume, it is possible to suppress the spread of the smell in the living space.

The information processing apparatus 100 calculates a score indicating the degree of generated wind or smell. Furthermore, the information processing apparatus 100 may calculate a score indicating a degree of influence on the living space by the generated wind or smell according to the capacity of the living space. Furthermore, the information processing apparatus 100 may calculate a score indicating the degree of wind or smell generated for the cooking appliance estimated to be used during cooking. Specifically, the information processing apparatus 100 may calculate a score indicating the degree of wind or smell generated for the ventilator estimated to be used during cooking. Then, in a case where the calculated score satisfies a predetermined threshold or more, the information processing apparatus 100 estimates that the generated wind or smell will spread over the entire living space.

Furthermore, the information processing apparatus 100 may control the non-cooking appliance such that the smell would not spread throughout the living space based on the arrangement information regarding the cooking appliance and the non-cooking appliance in the living space. For example, the information processing apparatus 100 may preferentially control a non-cooking appliance within a predetermined range from a cooking appliance that emits the smell. As a specific example, the information processing apparatus 100 may preferentially control the non-cooking appliance closest to the estimated cooking appliance, such as a case where a rice cooker or an oven is estimated based on the recipe information. For example, as a non-cooking appliance associated with the estimated cooking appliance such as a rice cooker or an oven, the information processing apparatus 100 may perform, in advance, control of opening and closing of a window closest to the estimated cooking appliance.

[2-3-3. Method for Controlling Sound]

FIG. 10 illustrates an example in which the information processing apparatus 100 controls a non-cooking appliance in order to suppress the influence of a sound generated during cooking. FIG. 10 illustrates a case where the information processing apparatus 100 estimates information regarding cooking that emits sound based on recipe information. For example, the information processing apparatus 100 estimates a cooking process using a cooking utensil such as a pot or a frying pan. For example, the information processing apparatus 100 estimates a cooking process of emitting a sound such as heating oil using a cooking utensil such as a pot or a frying pan. FIG. 10 illustrates a case where the information processing apparatus 100 estimates cooking appliances such as a gas stove and an electric stove based on recipe information. Hereinafter, description of processes similar to the heat control method and the wind or smell control method will be appropriately omitted.

The information processing apparatus 100 calculates a score indicating the degree of sound to be generated. Furthermore, the information processing apparatus 100 may calculate a score indicating a degree of influence on the living space by the generated sound according to the capacity of the living space. In a case where the calculated score satisfies a predetermined threshold or more, the information processing apparatus 100 estimates that the user will have a difficulty in sufficiently listening to the surrounding sound due to the generated sound. For example, the information processing apparatus 100 estimates that the user will have a difficulty in sufficiently listening to the sound outside the living space due to the sound generated during cooking. For example, the information processing apparatus 100 estimates that the user will have a difficulty in sufficiently listening to the sound emitted by the non-cooking appliance in the living space due to the sound generated during cooking. For example, the information processing apparatus 100 estimates that there will be a difficulty in sufficiently listening to a sound from a non-cooking appliance in a space different from a space including the cooking appliance emitting a sound during cooking.

Furthermore, the information processing apparatus 100 may control the non-cooking appliance so as to allow the user to sufficiently listen to the surrounding sounds. For example, the information processing apparatus 100 may perform control to increase the volume of the non-cooking appliance. For example, the information processing apparatus 100 may determine the interest of the user in an object provided by the non-cooking appliance, and perform control to increase the volume of the non-cooking appliance in a case where the interest of the user in the object provided by the non-cooking appliance is a predetermined threshold or more. As a specific example, the information processing apparatus 100 may determine the interest of the user in a program broadcast on television, and perform control to increase the volume of the television in a case where the interest of the user in the program on television is a predetermined threshold or more. With this control, the information processing apparatus 100 can appropriately control the volume so as to allow the user to sufficiently listen to the sound of the television even during cooking.

Furthermore, the information processing apparatus 100 may control the non-cooking appliance so as to allow the user to concentrate on cooking. For example, the information processing apparatus 100 may perform control to lower the volume of the non-cooking appliance. For example, the information processing apparatus 100 may determine the interest of the user in an object provided by the non-cooking appliance, and may perform control to lower the volume of the non-cooking appliance in a case where the interest of the user in the object provided by the non-cooking appliance is less than a predetermined threshold. As a specific example, the information processing apparatus 100 may determine the interest of the user in a program broadcast on television, and perform control to lower the volume of the television in a case where the interest of the user in the program on television is less than a predetermined threshold. With this control, the information processing apparatus 100 can provide the user with an environment that facilitates concentration on cooking.

[2-3-4. Method of Controlling Cooking Time]

In a case where the cooking time is prolonged or the like, the user might have difficulty performing other tasks related to life. In a case where the information processing apparatus 100 has estimated that the cooking time will be prolonged based on the recipe information, the information processing apparatus may notify the user in advance to perform other tasks related to life before cooking. For example, the information processing apparatus 100 may notify in advance a terminal device that is used routinely by the user to perform other tasks related to life before cooking.

Note that the information processing apparatus 100 may notify the user based on any information. For example, the information processing apparatus 100 may notify the user according to a set schedule which has been preset by the user regarding other tasks related to life. For example, the information processing apparatus 100 may make a notification based on an action history (action log) of other tasks related to life routinely performed by the user. Furthermore, the information processing apparatus 100 may notify the user by any notification method. For example, the information processing apparatus 100 may perform notification by push notification.

### 3. Variations of Processing

### 3-1. User's Comfortable Living Space Setting 1

By using the settings which make the user feels comfortable for each of the above-described factors, the user can presumably realize an ideal living space. For example, it is conceivable that the user makes settings such that the temperature of the living space is 25 degrees and the volume is 50 dB or less.

In this case, the information processing apparatus 100 receives the settings made by the user for each of the specific factors. For example, the information processing apparatus 100 receives the user's settings at a predetermined date and time before cooking. The information processing apparatus 100 acquires information regarding the degree of a comfortable environment in the living space according to the user's settings. For example, the information processing apparatus 100 acquires information regarding a degree of a comfortable environment in the living space, such as a comfortable temperature in the living space of 25 degrees, an intensity (level) of a comfortable wind or smell of 3 or less, and a comfortable volume of 50 dB or less.

The information processing apparatus 100 may control the non-cooking appliances so as to achieve the degree of the comfortable environment set by the user based on the information regarding the degree of the comfortable environment in the living space. Specifically, for each of the specific factors, the information processing apparatus 100 may control the non-cooking appliances so as to satisfy the degree of comfortable environment set by the user. More specifically, for each of the specific factors, the information processing apparatus 100 may control each of the corresponding non-cooking appliances so that the degree of the comfortable environment set by the user is satisfied in all of the corresponding specific factors. For example, the information processing apparatus 100 may control each of the corresponding non-cooking appliances so as to satisfy the degree of comfortable environment set by the user in a specific factor having a high priority of suppressing the influence of the specific factor among the corresponding specific factors.

Furthermore, the information processing apparatus 100 may control the non-cooking appliance based on an estimation that a comfortable environment set by the user is satisfied in the living space before cooking. Furthermore, the information processing apparatus 100 may control the non-cooking appliance so as to achieve the degree of comfortable environment set by the user while suppressing the influence of a specific factor occurring during cooking. A specific example will be described below.

In a case of estimating cooking processes such as simmering and baking based on the recipe information, the information processing apparatus 100 estimates that the temperature of the living space increases. In this case, it is assumed that the information processing apparatus 100 estimates that the comfortable temperature can be achieved by lowering the set temperature of the air conditioner by the temperature equivalent to the temperature of the living space estimated to rise due to the generated heat. In this case, lowering the set temperature of the air conditioner changes not only the intensity of heat but also the intensity of wind or smell in the living space. Here, the information processing apparatus 100 may estimate whether lowering the set temperature of the air conditioner will set the intensity of the wind or the smell generated to 3 or less, which is the intensity at which the user feels comfortable. In a case where the information processing apparatus estimates that lowering the set temperature of the air conditioner will set intensity of the wind or the smell generated to 3 or less, the information processing apparatus 100 may determine to lower the set temperature of the air conditioner by a temperature equivalent to the temperature of the living space estimated to rise. Furthermore, when having estimated that lowering the set temperature of the air conditioner will turn the intensity of the wind or the smell generated to exceed 3, the information processing apparatus 100 may estimate that the influence of the wind of the air conditioner will increase and determine to lower the set temperature of the air conditioner so as to decrease the lowering range of the set temperature of the air conditioner.

### 3-2. User's Comfortable Living Space Setting 2

The information processing apparatus 100 may determine the settings with which the user feels comfortable based on information regarding the lifestyle of the user. Specifically, the information processing apparatus 100 may determine the settings with which the user feels comfortable based on log information which is past information of the degree of the comfortable environment in the living space set by the user. For example, the information processing apparatus 100 may determine the settings with which the user feels comfortable based on the log information of the degree of the comfortable environment in the living space routinely defined by the user.

The information processing apparatus 100 may determine the settings with which the user feels comfortable based on log information for each predetermined cycle or period. For example, the information processing apparatus 100 may determine the settings with which the user feels comfortable based on log information for each predetermined cycle or period such as each hour, each day of the week, each month, or each year. For example, the information processing apparatus 100 may determine the settings with which the user feels comfortable based on log information for each predetermined cycle or period such as spring, summer, autumn, or winter. Furthermore, the information processing apparatus 100 may calculate statistical information which is information obtained statistically based on log information for each predetermined cycle or period, and determine the settings with which the user feels comfortable based on the calculated statistical information. For example, the information processing apparatus 100 may calculate an average, a median, a mode, and the like of setting values set by the user based on the log information for each predetermined cycle or period, and determine the calculated average, median, mode, and the like to be the settings with which the user feels comfortable.

In a case where the user routinely sets the temperature of the air conditioner to 27 degrees and the volume of the television to 10, the information processing apparatus 100 may determine that the temperature of the living space with which the user feels comfortable is 27 degrees and the volume with which the user feels comfortable is 10 dB or less. The information processing apparatus 100 may acquire the information regarding the degree of comfortable environment in the living space with the setting determined based on the information regarding the lifestyle of the user as the degree of comfortable environment in the living space.

### 3-3. Priority for Suppressing Influence of Specific Factor

The information processing apparatus 100 may determine the priority for suppressing the influence of a specific factor based on the recipe information. For example, it is assumed that the information processing apparatus 100 has estimated, based on recipe information, a cooking process of emitting heat, a cooking process of emitting wind or smell, and a cooking process of emitting sound. Here, the cooking process of emitting heat, the cooking process of emitting wind or smell, and the cooking process of emitting sound may indicate the same cooking process. That is, the cooking process of emitting heat, the cooking process of emitting wind or smell, and the cooking process of emitting sound may each be the cooking process of emitting heat, wind or smell, and sound. Specifically, it is assumed that the information processing apparatus 100 has estimated, based on the recipe information, a cooking process of emitting wind or smell at a high degree, a cooking process of emitting heat at a degree not higher than the degree of the cooking process of emitting wind or smell, and a cooking process of emitting sound at a degree not higher than the degree of the cooking process of emitting heat. Note that the degree here is the degree of influence by a specific factor. This includes an example of a case of cooking curry.

The information processing apparatus 100 may determine the priority of suppressing the influence of the specific factor based on the degree of influence of the specific factor. For example, the information processing apparatus 100 may determine the priority of suppressing the influence of a specific factor in descending order of the degree of influence of the specific factor. For example, the information processing apparatus 100 may determine the priority of suppressing the influence of wind or smell to be the highest priority. For example, the information processing apparatus 100 may determine the priority of suppressing the influence of heat as the priority next to the priority of suppressing the influence of wind or smell. For example, the information processing apparatus 100 may determine the priority for suppressing the influence of sound as the priority next to the priority for suppressing the influence of heat. In this case, the priority order of the specific factor the influence of which is to be suppressed by the information processing apparatus 100 is the order of wind or smell, heat, and sound. Note that the information processing apparatus 100 may determine the priority of suppressing the influence of a specific factor for each cooking process. Hereinafter, a process of determining the priority of suppressing the influence of a specific factor will be described using a specific example.

When stewing vegetables in a pot, the information processing apparatus 100 may estimate that the influence of wind or smell is not high and determine the priority of suppressing the influence of heat to be the highest priority. Thereafter, when roux or curry sauce mix is added to the pot after the vegetables are stewed in the pot, the information processing apparatus 100 may estimate that the influence of the wind or the smell increases, and may determine the priority of suppressing the influence of the wind or the smell to be the highest priority. Note that, even during the same cooking process, the information processing apparatus 100 may change the priority of suppressing the influence of a specific factor according to the change in the influence of cooking. For example, this is a case where the process of stewing vegetables in a pot and the process of adding roux or curry sauce mix to the pot and continuing stewing are in the same cooking process.

### 3-4. Optimal Method of Selecting Non-Cooking Appliance

The information processing apparatus 100 may determine the non-cooking appliance being a control target based on the degree of influence of a specific factor. For example, the information processing apparatus 100 may determine a non-cooking appliance being a control target among the corresponding non-cooking appliances according to a specification regarding suppression of an influence of a specific factor. Here, the specification is the specification illustrated in FIG. 7. Specifically, the information processing apparatus 100 may determine the non-cooking appliance being a control target among the non-cooking appliances associated with the cooking appliance that can be a source of a specific factor during cooking, according to a specification regarding suppression of an influence of a corresponding specific factor. As a specific example, the information processing apparatus 100 may determine the non-cooking appliance being a control target among the non-cooking appliances associated with the cooking appliance having a possibility of emitting heat during cooking in accordance with specifications regarding suppression of the influence of the generated heat.

The information processing apparatus 100 may determine the non-cooking appliance being a control target according to the priority of suppressing the influence of a specific factor. For example, in a case where the priority of suppressing the influence of a specific factor is high, the information processing apparatus 100 determines, from among the corresponding non-cooking appliances, a non-cooking appliance having high specifications regarding suppression of the influence of a specific factor to be the non-cooking appliance being a control target. For example, in a case where the priority of suppressing the influence of a specific factor is not high, the information processing apparatus 100 may determine, from among the corresponding non-cooking appliances, a non-cooking appliance having high efficiency related to power consumption even without quickness as a specification regarding suppression of the influence of a specific factor to be the non-cooking appliance being a control target.

### 3-5. Optimal Method of Selecting Non-Cooking Appliance in Consideration of External Environment

The information processing apparatus 100 may determine a non-cooking appliance being a control target based on information regarding an external environment being a space external to the living space. Here, example of the information regarding the external environment include weather conditions (for example, sunny, cloudy, rainy, snowy, etc.), temperature, humidity, wind intensity, and a degree of air pollution (for example, PM 2.5). The information processing apparatus 100 may change the priority of the non-cooking appliance based on the information regarding the external environment, and may determine the non-cooking appliance being a control target based on the changed priority of the non-cooking appliance. As a specific example, in a case where the information processing apparatus 100 has estimated that the space external to the living space is rainy based on the information regarding the external environment, it is allowable to estimate a possibility of entrance of rain by opening the window of the living space, and may lower the priority of the electric window while raise the priority of the electric fan, or may change either one of the priorities.

Furthermore, the information processing apparatus 100 may delete a predetermined non-cooking appliance from the candidates of the non-cooking appliance being a control target based on the information regarding the external environment. As a specific example, in a case where the information processing apparatus 100 has estimated that the space external to the living space is rainy based on the information regarding the external environment, it is allowable to estimate a possibility of entrance of rain by opening the window of the living space, and may delete the electric window from the candidates of the non-cooking appliance being a control target. For example, the information processing apparatus 100 may set the priority of the electric window to a predetermined value determined in advance, and may substantially delete the electric window from the candidates of the non-cooking appliance being a control target.

### 3-6. Optimal Method of Selecting Non-Cooking Appliance in Consideration of User Situation

The information processing apparatus 100 may determine the non-cooking appliance being a control target based on information regarding the user situation which indicates the situation of the user. Here, examples of the information regarding the user situation include a state in which the user is going to cook while listening to music and a state in which the user is going to cook while watching television. The information processing apparatus 100 may change the priority of the non-cooking appliance based on the information regarding the user situation, and may determine the non-cooking appliance being a control target based on the changed priority of the non-cooking appliance. As a specific example, when having estimated that the user is going to cook while listening to music based on the information regarding the user situation, the information processing apparatus 100 may estimate that the air conditioner emits loud sound which has a possibility of preventing the user from enjoying listening to music, and may then lower the priority of the air conditioner and raise the priority of the electric heater or the floor heating, or may change the priority of either one of these.

Note that the change in the priority of the non-cooking appliance may be a temporary change. For example, the priority of the non-cooking appliance may be changed until the user finishes listening to music or until the user finishes watching television. For example, the information processing apparatus 100 may estimate the time when the user finishes listening to music based on the playback time of the music or the like. For example, when having estimated that the user will finish listening to music during cooking, the information processing apparatus 100 may determine the priority of the non-cooking appliance for the time after the estimated time when the user finishes listening to music to the priority of the state before the change. In this manner, the information processing apparatus 100 may temporarily change the priority of the non-cooking appliance based on the information regarding the user situation, and may determine the non-cooking appliance being a control target based on the temporarily changed priority of the non-cooking appliance.

The information processing apparatus 100 may determine the non-cooking appliance being a control target based on information regarding the preference of the user. For example, the information processing apparatus 100 may determine the non-cooking appliance being a control target based on information regarding the preference of the user and information regarding the user situation. Specifically, the information processing apparatus 100 may estimate the information regarding the user situation based on the information regarding the preference of the user, and may determine the non-cooking appliance being a control target based on the estimated information regarding the user situation. As a specific example, when having estimated that the target music is music of interest to the user based on information regarding the preference of the user, the information processing apparatus 100 may estimate that the user is going to cook while listening to the music, and may determine the non-cooking appliance being a control target. In contrast, when having estimated that the target music is music of no interest to the user based on the information regarding the preference of the user, the information processing apparatus 100 may estimate that the user is trying to concentrate on cooking, and determine the non-cooking appliance being a control target without changing the priority of the non-cooking appliance.

Furthermore, the information processing apparatus 100 may change the priority of the non-cooking appliance based on the information regarding the preference of the user, the information regarding the user situation, and the information regarding external environment, and may determine the non-cooking appliance being a control target based on the changed priority of the non-cooking appliance.

### 3-7. Determination of Timing Related to Cooking

Hereinafter, processing in which the information processing apparatus 100 determines a user's timing related to cooking will be described. For example, the information processing apparatus 100 determines the user's timing related to cooking based on one of the following two cases.

[3-7-1. Inputting Timing by User with Intention]

When the user has input a timing related to cooking with intention, the information processing apparatus 100 determines the input timing as a predetermined timing related to cooking. Here, the timing related to cooking may be any timing. For example, the timing related to cooking may be a timing of starting cooking. For example, the timing related to cooking may be a timing of finishing cooking. For example, the timing related to cooking may be the timing of taking the meal. Note that the information processing apparatus 100 may receive an input of timing related to cooking by the user based on any means. For example, the information processing apparatus 100 may receive an input of timing related to cooking based on an operation of the user on a UI screen. For example, the information processing apparatus 100 may receive an input of timing related to cooking via a voice agent.

[3-7-2. Determination of Timing Based on User's Action]

The information processing apparatus 100 determines a predetermined timing related to cooking based on a user's action related to cooking. For example, the information processing apparatus 100 may determine the timing at which the user starts an action related to cooking to be the timing of starting cooking. For example, the information processing apparatus 100 may determine the timing at which the user starts an operation on a cooking appliance to be the cooking start timing based on the user's operation on the cooking appliance. For example, the information processing apparatus 100 may determine the timing at which the user turns on a switch of the cooking appliance to be the cooking start timing based on the user's operation on the cooking appliance. For example, the information processing apparatus 100 may determine a timing at which a switch of a cooking appliance predetermined as the cooking appliance for determination of the cooking start timing is turned on to be the cooking start timing. For example, the information processing apparatus 100 may determine the timing at which the user turns off the switch of the cooking appliance to be a cooking end timing based on the user's operation on the cooking appliance. For example, the information processing apparatus 100 may determine the timing at which the switch of a cooking appliance predetermined as a cooking appliance for determination of the timing of the end of cooking is turned off to be the timing of the end of cooking. For example, the information processing apparatus 100 may determine the timing at which the user has moved from a space including a cooking appliance to another space in the living space to be the timing at which the user takes the meal. Specifically, the information processing apparatus 100 may determine the timing at which the user moves from the kitchen to the dining room to be the timing at which the user takes the meal. More specifically, the information processing apparatus 100 may determine the timing at which the user moves the cooking utensil such as a pot from the kitchen to the dining room to be the timing at which the user takes the meal.

In the embodiment, there is no need to match the timing at which the user determines the recipe with the timing at which the user starts cooking. Furthermore, in the embodiment, there is no need to match timing at which the user finishes cooking with the timing at which the user takes the meal.

### 3-8. Others

Other details according to the embodiment will be described below.

[3-8-1. Living Space According to Embodiment]

The living space according to the embodiment may be any living space that can affect the comfort of the user. For example, the living space according to the embodiment may be any space such as a kitchen, a living room, a dining room, a living room, a room, a corridor, or a bathroom. In addition, the living space according to the embodiment is not limited to a living space of a stationary object, and may be a living space of a moving object. For example, the living space according to the embodiment may be a living space of a stationary object such as an apartment or a house. For example, the living space according to the embodiment may be a living space of a moving object such as an airplane, a ship, or a car. In addition, the living space according to the embodiment is not limited to the living space on the ground, and may be a living space under the ground (underground). Furthermore, the living space according to the embodiment may be a living space on another planet or in space as long as it is a space regarded as a living space. In addition, the living space according to the embodiment is not limited to a living space of a property owned by an individual, and may be a living space of a property owned by a corporation. For example, the living space according to the embodiment may be a living space of an object such as a building or a research facility owned by a company, a university, or the like.

[3-8-2. Smell According to Embodiment]

The smell according to the embodiment may be any smell that can affect the comfort of the user. For example, the smell according to the embodiment may be any smell of a chemical substance that can be sensed by the olfactory receptor of the user. For example, the smell according to the embodiment is not limited to a smell that threatens the comfort of the user, and may be a smell that increases the comfort of the user. For example, the smell according to the embodiment may be a terrible smell that threatens the comfort of the user. For example, the smell according to the embodiment may be a bad smell that threatens the comfort of the user. For example, the smell according to the embodiment may be a “scent” that increases user's comfort. For example, the smell according to the embodiment may be fragrance that increases user's comfort.

Note that the smell according to the embodiment may be any smell that is emitted during cooking. For example, the smell according to the embodiment is not limited to the smell emitted due to an ingredient in the recipe, and may be a smell emitted due to the cooking process. For example, the smell according to the embodiment may be a smell emitted due to an ingredient in the recipe, such as garlic, durian, or spice. For example, the smell according to the embodiment may be a smell of a volatile substance included in the recipe. For example, the smell according to the embodiment may be a smell emitted due to the cooking processes such as baking, simmering, boiling, and steaming. In addition, the smell according to the embodiment may be a substance related to water such as water vapor or steam. For example, the smell according to the embodiment may be water vapor or steam generated by a cooking appliance such as a rice cooker or a cooking process such as steaming. For example, the smell according to the embodiment may be smoke or the like. For example, the smell according to the embodiment may be a carbon substance such as smoke generated by a cooking process such as baking or simmering.

Note that the smell according to the embodiment may be smell of any type or intensity. For example, the smell according to the embodiment is not limited to the smell of a type or level that can be sensed by an olfactory receptor of a human, and may be a smell of a type or level that can be sensed by an olfactory receptor of another animal. For example, the smell according to the embodiment may be a smell of a chemical substance that can be sensed by an olfactory receptor of another animal such as a dog, cat, monkey, bird, or fish, not limited to human.

[3-8-3. Heat According to Embodiment]

The influence of heat according to the embodiment is not limited to the influence of an increase in the temperature of the living space, and may be the influence of a decrease in the temperature of the living space. For example, the influence of heat according to the embodiment may be an influence of a decrease in the temperature of the living space, such as a case where the user opens the refrigerator during cooking. For example, the influence of heat according to the embodiment may be an influence of a decrease in the temperature of the living space, such as a case where the user cooks with liquid nitrogen.

Furthermore, the influence of heat according to the embodiment may be different based on a perceived temperature of the user. Here, the perceived temperature according to the embodiment is not an actual temperature of the living space measured by a sensor such as a thermometer but a temperature physically felt by the user. For example, even when the actual temperature of the living space is 28 degrees, it may be felt warmer than the actual temperature of the living space or it may be felt colder than the actual temperature of the living space depending on the user's perception of the temperature. For example, even when the temperature of the living space increases by one degree, it may be felt depending on the user's perception of temperature that the temperature of the living space has increased by one degree or more, or it may be felt that there is no change in the temperature of the living space. Furthermore, user's perception may be different depending on attribute of the user (for example, demographic attributes such as gender and age), the physical condition of the user, or the sensitivity of the user. Note that the perceived temperature according to the embodiment may match the measured temperature of the living space. For example, the degree of influence by heat according to the embodiment may be estimated based on the perceived temperature of the user. As a specific example, in a case where the recipe includes a large amount of red ingredients, the information processing apparatus 100 may estimate that the perceived temperature of the user is likely to increase, and may estimate the degree of influence by heat during cooking to be higher than usual. For example, in a case where the recipe includes a large amount of green ingredients, the information processing apparatus 100 may estimate that the perceived temperature of the user is likely to be lowered, and estimate the degree of influence by heat during cooking to be lower than usual. As another example, in a case where the information processing apparatus has estimated that there are many processes using a burner based on recipe information, the information processing apparatus 100 may estimate that the perceived temperature of the user is likely to increase, and may estimate the degree of influence by heat during cooking to be higher than usual. For example, in a case where the information processing apparatus 100 has estimated that there are many processes using ice based on the recipe information, the information processing apparatus may estimate that the perceived temperature of the user is likely to be lowered and estimate the degree of influence by heat during cooking to be lower than usual.

[3-8-4. Cooking According to Embodiment]

The cooking according to the embodiment is not limited to cooking based on a plurality of cooking processes, and may be cooking based on one cooking process. For example, the cooking according to the embodiment may be cooking which is simple and easy based on one cooking process such as pouring hot water and waiting for 3 minutes.

[3-8-5. Cooking Process According to Embodiment]

The cooking process according to the embodiment may be any event as long as it is a process related to cooking. For example, the cooking process according to the embodiment is not limited to a process using a cooking utensil such as baking, simmering, boiling, steaming, cutting, peeling, or beating, and may be a process performed by a user's action such as putting milk in a cup or carrying a pot to the dining room. For example, the cooking process according to the embodiment may be a process in which an instrument (for example, a centrifuge) used in research in the field of natural science or the like is used for cooking.

[3-8-6. Recipe According to Embodiment]

The recipe according to the embodiment may be any recipe as long as it is a recipe related to cooking. In addition, the recipe according to the embodiment is not limited to the ingredients for cooking, and may include a finished product of cooking. In addition, the recipe according to the embodiment may include a product (intermediates) generated by the cooking process. For example, the recipe according to the embodiment may include each of sugar, soy sauce, and mirin, or may be a mixture generated from the process of mixing sugar, soy sauce, and mirin. In addition, the recipe according to the embodiment may be a cooking process. For example, the recipe according to the embodiment may be a cooking process using ingredients for cooking. For example, the recipe according to the embodiment may be a cooking process including adding 5 grams of sugar, stewing vegetables in a pot for 10 minutes, stewing vegetables in a pot for 10 minutes then adding roux or curry sauce mix and further stewing for 10 minutes, or the like.

[3-8-7. Imaging Information According to Embodiment]

Imaging information according to the embodiment is not limited to imaging information mainly targeted for cooking, and may be any information as long as the imaging information includes information regarding cooking. For example, the imaging information according to the embodiment may be imaging information including information regarding cooking in a predetermined region. Furthermore, the imaging information according to the embodiment is not limited to information having a subject such as a video or an image, and may be information that gives the user mental association of information regarding cooking. For example, the imaging information according to the embodiment may be character information giving mental association of a video or an image regarding cooking, such as “how to make delicious curry”. For example, the imaging information according to the embodiment may be smell information giving mental association of a video or an image related to cooking via a scented screen (display) that releases a smelling substance in conjunction with the video or the image. Here, the scented screen may be a display referred to as an olfactory display, for example. Furthermore, the imaging information according to the embodiment may be information obtained by distorting a cooking video, a cooking image, or the like (examples of the information include comics, illustrations, icons, animations, and the like). Furthermore, the imaging information according to the embodiment may be imaging information including information regarding a plurality of recipes of a plurality of different types of cooking. Specifically, this includes a case where information regarding a plurality of recipes of a plurality of cooking such as a recipe of curry and a recipe of a hot pot is included as a plurality of different cooking in one page of a magazine.

[3-8-8. Specific Factor According to Embodiment]

In the embodiment, the heat, the wind or the smell, the sound, the time, and the like are illustrated as examples of the factor that affects the comfort of the user. However, the factor is not limited to these examples. The factor according to the embodiment may be any factor that can affect the living space of the user. The factor according to the embodiment may be any factor generated by an event regarded as cooking. For example, the factor according to the embodiment may be color or brightness. Specifically, the factor according to the embodiment may be a color or brightness due to lighting used during cooking. Specifically, the factor according to the embodiment may be a color or brightness due to heat of an appliance used during cooking. In addition, the factor according to the embodiment may be a factor due to an event immediately before the user takes the meal. For example, the factor according to the embodiment may be heat generated when the user opens the lid of the pot immediately before the meal.

[3-8-9. Selecting Plurality of Non-Cooking Appliances]

When there is a plurality of non-cooking appliances associated with the cooking appliance, for example, the information processing apparatus 100 may determine a non-cooking appliance associated with the estimated cooking appliance to be a candidate for the non-cooking appliance being a control target. In this case, the information processing apparatus 100 may perform information processing on a plurality of candidates for the non-cooking appliance as control targets. For example, the information processing apparatus 100 may perform information processing on a plurality of candidates satisfying a predetermined condition among a plurality of candidates for a non-cooking appliance as control targets. Furthermore, the information processing apparatus 100 may perform information processing on one non-cooking appliance that most satisfies a predetermined condition among a plurality of candidates for the non-cooking appliance being a control target.

[3-8-10. “Listen” and “View” According to Embodiment]

Although the embodiment has used the word “listen” in description, the word “listen” according to the embodiment may be replaced with “hear”. The “listen” according to the embodiment may represent either “hear” a sound that naturally enters the user's ear, or “listen” to the sound with user's attention. Furthermore, although the embodiment uses the word “watch” in description, the word “watch” according to the embodiment may be replaced with “view”. The “watch” according to the embodiment may represent either “view” an event that naturally enters the user's vision, or “watch” the event with user's attention.

[3-8-11. Timing Before Predetermined Process According to Embodiment]

The above-described embodiment has described the case where the control of the non-cooking appliance being a control target is performed before the cooking by the user at a timing before a predetermined process. Here, the timing before the predetermined process according to the embodiment is not limited to the timing before cooking by the user or the timing before the first cooking process, but may be a timing before a predetermined cooking process after the first cooking process, or may be a timing before a meal, that is, before the user takes a cooked food. In this case, the information processing apparatus 100 may control the non-cooking appliance not only before the cooking performed by the user, but also before a predetermined cooking process after the first cooking process. That is, the information processing apparatus 100 may control the non-cooking appliance during cooking performed by the user. With this control, the information processing apparatus 100 can appropriately control the non-cooking appliance according to the cooking status of the user. Furthermore, the information processing apparatus 100 may control the non-cooking appliance before the user takes a meal. This enables the information processing apparatus 100 to provide a comfortable living space environment for the user at the time of taking the meal.

[3-8-12. Determination of User's Interest Using Biometric Information of User]

The embodiment described above has described the case where the information processing apparatus 100 estimates the recipe that the user desires to use for cooking based on the information regarding the user's line of sight such as the user's gaze time and dilation and constriction of the pupil for the imaging information. Here, the information processing apparatus 100 may estimate the recipe that the user desires to use for cooking based on not only the line of sight but also any type of biometric information. For example, the information processing apparatus 100 may estimate a recipe that the user desires to use for cooking based on biometric information such as the user's blood pressure, pulse, electrocardiogram, skin potential (skin conductance), and cerebral blood flow. As a specific example, the information processing apparatus 100 may estimate a recipe that the user desires to use for cooking based on biometric information regarding cerebral blood flow that is active in relation to generation of saliva when the user has an appetite. Here, the state in which the cerebral blood flow is active is a state, for example, in which the increase rate of the concentration of oxygenated hemoglobin is a predetermined threshold or more. Furthermore, the information processing apparatus 100 may estimate a recipe that the user desires to use for cooking based on the user's line-of-sight information and biometric information other than the line of sight. As a result, the information processing apparatus 100 can improve the accuracy of estimating the recipe that the user desires to use for cooking even in a case where the user simultaneously views a plurality of recipes of a plurality of different cooking.

[3-8-13. Method for Displaying Specification of Non-Cooking Appliance]

In the above-described embodiment, the effect of the non-cooking appliance on the specific factor is represented by double circles indicating that the effect of the non-cooking appliance on the specific factor is extremely high, single circles indicating that the effect of the non-cooking appliance on the specific factor is high, and bar lines indicating that the effect of the non-cooking appliance on the specific factor is not extremely high, that is, ineffective. However, the method of indicating the effect of the non-cooking appliance on the specific factor is not limited to this example, and any method may be used. For example, the effect of the non-cooking appliance on a specific factor may be indicated using numerical values in three stages of “5=extremely effective, 3=effective, 1=ineffective”. As a specific example, when the effect of the air conditioner on heat is extremely high, the air conditioner may be set to “5”. For example, the effect of the non-cooking appliance on a specific factor may be indicated using characters in four stages of “A=extremely effective, B=effective, C=less effective, F=ineffective”. As a specific example, when the effect of the air conditioner on heat is extremely high, the air conditioner may be set to “A”.

[3-8-14. Estimation Processing Based on Recipe Information]

The above-described embodiment is the case of estimating the cooking ingredients, the cooking utensil, the cooking process, and the like regarding the cooking performed by the user based on recipe information. Here, estimation processing of estimating cooking ingredients, cooking utensils, cooking processes, and the like based on recipe information will be described. For example, the information processing apparatus 100 estimates cooking ingredients, cooking utensils, cooking processes, and the like based on character information included in recipe information. For example, the information processing apparatus 100 performs morphological analysis on character information included in recipe information to specify character information indicating cooking ingredients, cooking utensil, cooking process, and the like, and estimates the cooking ingredients, cooking utensil, cooking process, and the like related to user's cooking. Note that the information processing apparatus 100 may specify information indicating cooking ingredients, cooking utensil, cooking process, and the like and estimate the cooking ingredients, the cooking utensil, the cooking process, and the like related to the user's cooking, based on any information by which it is possible to specify the cooking ingredients, the cooking utensil, the cooking process, and the like, not limited to character information. Furthermore, the information processing apparatus 100 may specify information indicating cooking ingredients, cooking utensil, cooking process, and the like and estimate the cooking ingredients, the cooking utensil, the cooking process, and the like related to the user's cooking, based on any method by which it is possible to specify the cooking ingredients, the cooking utensil, the cooking process, and the like, not limited to morphological analysis of character information.

[3-8-15. Method of Calculating Distance from Cooking Appliance]

The embodiment described above is a case where the non-cooking appliance being a control target is preferentially selected based on the distance from the cooking appliance estimated based on the recipe information. For example, the above-described embodiment is a case where the control is preferentially performed from the non-cooking appliance closest to the estimated cooking appliance based on the recipe information. Here, the distance from the cooking appliance according to the embodiment may be a two-dimensional distance. Specifically, the distance from the cooking appliance according to the embodiment may be a distance indicated by a floor plan when the living space is viewed from directly above. More specifically, the distance from the cooking appliance according to the embodiment may be a distance between the cooking appliance and the non-cooking appliance indicated by a floor plan when the living space is viewed from directly above. In addition, the distance from the cooking appliance according to the embodiment may be a three-dimensional distance. Specifically, the distance from the cooking appliance according to the embodiment may be a distance indicated by a floor plan of the living space viewed from directly above and a plan view of the living space viewed directly from the side. More specifically, the distance from the cooking appliance according to the embodiment may be a distance geometrically calculated based on a distance between the cooking appliance and the non-cooking appliance illustrated in a floor plan of the living space viewed from directly above and a distance between the cooking appliance and the non-cooking appliance illustrated in a plan view of the living space viewed directly from the side.

In addition, the distance from the cooking appliance according to the embodiment is not limited to the shortest distance connecting the cooking appliance and the non-cooking appliance with a straight line, and may be a distance according to the structure of the living space. For example, in a case where the direct distance connecting the cooking appliance and the non-cooking appliance at the shortest is obstructed by the structure of the living space such as a wall, the information processing apparatus 100 may select the shortest distance between the cooking appliance and the non-cooking appliance so as not to be obstructed by the structure of the living space. For example, in a case where the direct distance connecting the cooking appliance and the non-cooking appliance at the shortest is obstructed by an object (for example, doors, curtains, other cooking appliances, and the like) present in the living space, the information processing apparatus 100 may select the shortest distance between the cooking appliance and the non-cooking appliance so as to avoid the object present in the living space.

### 4. Configuration of Information Processing Apparatus

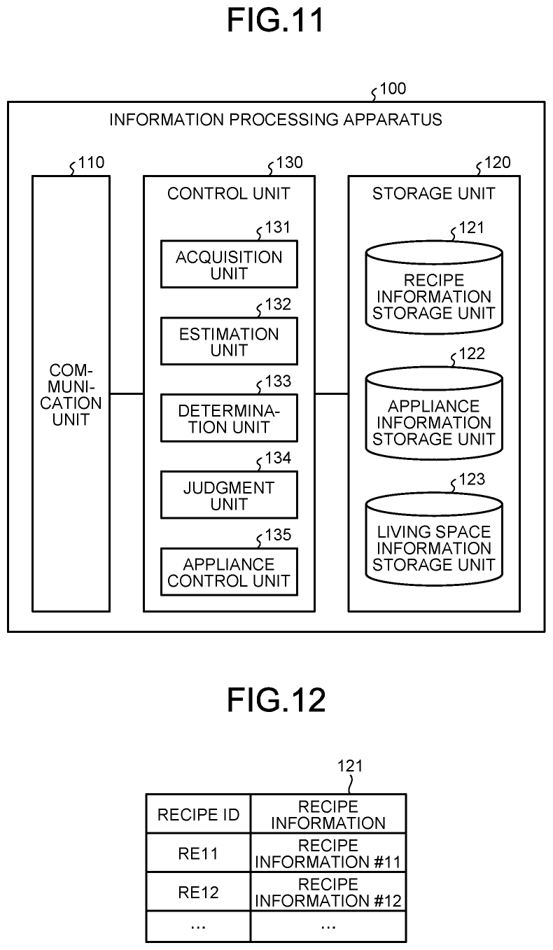

Next, a configuration of the information processing apparatus 100 according to the embodiment will be described with reference to FIG. 11. FIG. 11 is a diagram illustrating a configuration example of the information processing apparatus 100 according to the embodiment. As illustrated in FIG. 11, the information processing apparatus 100 includes a communication unit 110, a storage unit 120, and a control unit 130. The information processing apparatus 100 may include an input unit (for example, a keyboard, a mouse, etc.) that receives various operations from an administrator of the information processing apparatus 100, and a display unit (for example, a liquid crystal display, etc.) for displaying various types of information.

(Communication Unit 110)

The communication unit 110 is actualized by a network interface card (NIC), for example. Then, the communication unit 110 is connected to the network N in a wired or wireless connection, and transmits and receives information to and from the sensor 10 and the like via the network N. Furthermore, the communication unit 110 may communicate by selectively connecting to a plurality of communication networks.

(Storage Unit 120)

The storage unit 120 is implemented by semiconductor memory elements such as random access memory (RAM) and flash drives, or storage devices such as a hard disk or an optical disk. As illustrated in FIG. 11, the storage unit 120 includes a recipe information storage unit 121, an appliance information storage unit 122, and a living space information storage unit 123.

The recipe information storage unit 121 stores recipe information. For example, the recipe information storage unit 121 stores information regarding the cooking ingredients and information regarding the cooking process. Here, FIG. 12 illustrates an example of the recipe information storage unit 121 according to the embodiment. As illustrated in FIG. 12, the recipe information storage unit 121 includes items such as “recipe ID” and “recipe information”.

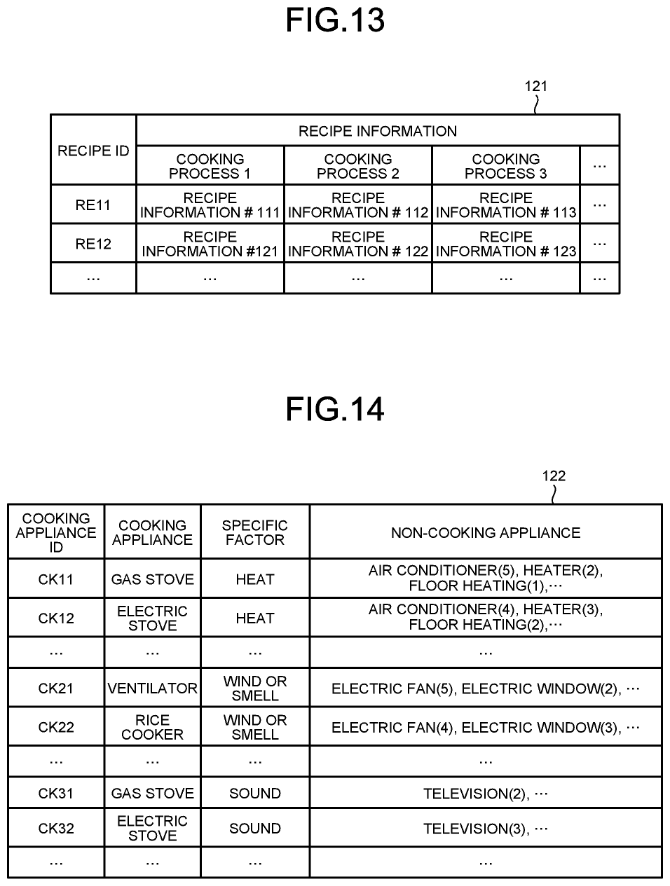

The “recipe ID” indicates identification information for identifying recipe information. The “recipe information” indicates information regarding recipes. Although the example in FIG. 12 illustrates an example in which “recipe information” stores conceptual information such as “recipe information #11” and “recipe information #12”, “recipe information” in practice stores recipe information regarding cooking. For example, the “recipe information” may store information regarding cooking ingredients. For example, the “recipe information” may store information regarding cooking utensils. For example, the “recipe information” may store information regarding the cooking process. As illustrated in FIG. 13, the “recipe information” may store recipe information for each cooking process.

FIG. 13 illustrates an example of the recipe information storage unit 121 according to the embodiment. As illustrated in FIG. 13, the recipe information storage unit 121 further includes items such as “cooking process 1”, “cooking process 2”, and “cooking process 3”. “Cooking process*” indicates recipe information regarding a cooking process corresponding to “*”. For example, “cooking process 1” indicates recipe information regarding a first cooking process. For example, “cooking process 2” indicates recipe information regarding a cooking process after the first cooking process. Although the example in FIG. 13 illustrates an example in which “cooking process*” stores conceptual information such as “recipe information #11*” and “recipe information #12*”, “cooking process*” in practice stores recipe information regarding cooking for each cooking process.

The appliance information storage unit 122 stores association information between the cooking appliance and the non-cooking appliance. Here, FIG. 14 illustrates an example of the appliance information storage unit 122 according to the embodiment. As illustrated in FIG. 14, the appliance information storage unit 122 includes items such as “cooking appliance ID”, “cooking appliance”, “specific factor”, and “non-cooking appliance”.

The “cooking appliance ID” indicates identification information for identifying cooking appliances. “Cooking appliance” indicates an appliance used for cooking. The “specific factor” indicates a specific factor that occurs due to the use of the cooking appliance. “Non-cooking appliance” indicates a non-cooking appliance associated with “cooking appliance”. For example, “non-cooking appliance” indicates that the non-cooking appliance associated with a gas stove includes an air conditioner, a heater, floor heating, and the like. “(*)” written together with the non-cooking appliance indicates a specification of the non-cooking appliance to suppress an influence of a corresponding specific factor. Here, it is assumed that specifications are indicated in five levels of (1) to (5) using the order from higher specification to lower specification, such that “the higher the number, the higher the specification from (5)=high specification to (1)=low specification”. For example, air conditioner (5) indicates a high specification non-cooking appliance. For example, floor heating (1) indicates a low specification non-cooking appliance. FIG. 14 illustrates that an air conditioner is a high-specification non-cooking appliance regarding the specification of suppressing the influence of heat generated from the use of a gas stove. In addition, floor heating is a high-specification non-cooking appliance regarding the specification of suppressing the influence of heat generated from the use of a gas stove.

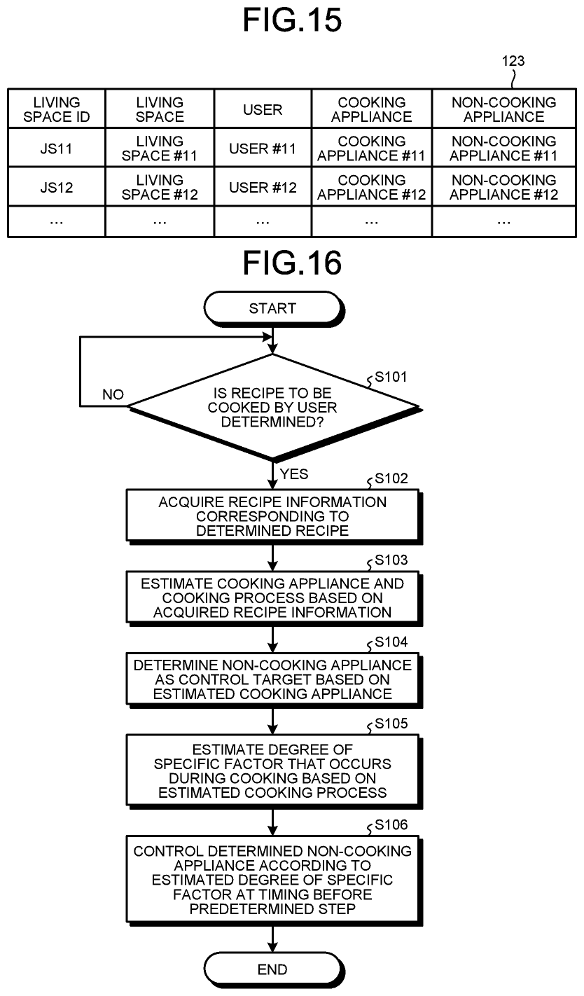

The living space information storage unit 123 stores information regarding a living space. For example, the living space information storage unit 123 stores information regarding a user living in the living space and information regarding an appliance present in the living space. Here, FIG. 15 illustrates an example of the living space information storage unit 123 according to the embodiment. As illustrated in FIG. 15, the living space information storage unit 123 includes items such as “living space ID”, “living space”, “user”, “cooking appliance”, and “non-cooking appliance”.

The “living space ID” indicates identification information for identifying the living space. The “living space” indicates information regarding a living space. The example illustrated in FIG. 15 is an example in which “living space” stores conceptual information such as “living space #11” and “living space #12”. However, in practice, “living space” stores information such as a living space structure (for example, a two-dimensional (2D) structure, a three-dimensional (3D) structure, a material of a living space, and the like), a capacity of the living space, and a capacity and positional information of a small space which is a space existing in the living space as well as being a space dividing the living space. The “user” indicates information regarding a user living in the living space. Furthermore, the “user” is not limited to information regarding a single user, and may indicate information regarding a plurality of users. Furthermore, the “user” is not limited to the information regarding the user estimated to cook, and may indicate information regarding other users, that is, users other than the user estimated to cook. The example illustrated in FIG. 15 is an example in which “user” stores conceptual information such as “user #11” and “user #12”. However, in practice, “user” stores information such as information regarding preference of the user and information regarding attribute of the user. The “cooking appliance” indicates information regarding a cooking appliance existing in the living space. The example illustrated in FIG. 15 is an example in which “cooking appliance” stores conceptual information such as “cooking appliance #11” and “cooking appliance #12”. However, in practice, “cooking appliance” stores information such as a name of the cooking appliance and arrangement information regarding the cooking appliance in the living space. The “non-cooking appliance” indicates information regarding a non-cooking appliance existing in the living space. The example illustrated in FIG. 15 is an example in which “non-cooking appliance” stores conceptual information such as “non-cooking appliance #11” and “non-cooking appliance #12”. However, in practice, “non-cooking appliance” stores information such as a name of the non-cooking appliance and arrangement information regarding the non-cooking appliance in the living space.

(Control Unit 130)

The control unit 130 is a controller, and is implemented by execution of various programs stored in a storage device inside the information processing apparatus 100 by a CPU, an MPU, or the like, using RAM as a work area. Furthermore, the control unit 130 is a controller and is actualized by using an integrated circuit such as an ASIC or an FPGA, for example.

As illustrated in FIG. 11, the control unit 130 includes an acquisition unit 131, an estimation unit 132, a determination unit 133, a judgment unit 134, and an appliance control unit 135, and implements or executes operational effects of information processing described below. The internal configuration of the control unit 130 is not limited to the configuration illustrated in FIG. 11, and may be another configuration as long as it is a configuration that performs information processing described below.

(Acquisition Unit 131)

The acquisition unit 131 acquires various types of information. The acquisition unit 131 acquires various types of information from an external information processing apparatus. The acquisition unit 131 acquires various types of information from another information processing apparatus such as the sensor 10.

The acquisition unit 131 acquires various types of information from the storage unit 120. The acquisition unit 131 acquires various types of information from the recipe information storage unit 121, the appliance information storage unit 122, and the living space information storage unit 123.

The acquisition unit 131 stores the acquired various types of information in the storage unit 120. The acquisition unit 131 stores various types of information in the recipe information storage unit 121, the appliance information storage unit 122, and the living space information storage unit 123.

The acquisition unit 131 acquires various types of information estimated, determined, and judged by other functional configurations.

The acquisition unit 131 acquires recipe information that is information regarding cooking performed by the user.

The acquisition unit 131 acquires information regarding a cooking appliance in the living space. For example, the acquisition unit 131 acquires arrangement information regarding the cooking appliance.

The acquisition unit 131 acquires information regarding a non-cooking appliance in the living space. For example, the acquisition unit 131 acquires arrangement information regarding the non-cooking appliance.

The acquisition unit 131 acquires sensor information that is information detected by the sensor 10. For example, the acquisition unit 131 acquires various sensor information detected by the various sensors 10. For example, the acquisition unit 131 acquires sensor information detected as information regarding the user's situation and behavior.

The acquisition unit 131 acquires information regarding the user in the living space. For example, the acquisition unit 131 acquires information regarding preference of the user and information regarding attribute of the user.

(Estimation Unit 132)

The estimation unit 132 estimates various types of information. The estimation unit 132 estimates various types of information from the storage unit 120. The estimation unit 132 estimates various types of information from the recipe information storage unit 121, the appliance information storage unit 122, and the living space information storage unit 123.

The estimation unit 132 estimates various types of information acquired, determined, and judged by other functional configurations. Furthermore, the estimation unit 132 estimates various types of information based on various types of information acquired, determined, and judged by other functional configurations.

The estimation unit 132 estimates information related to cooking. For example, the estimation unit 132 estimates information related to cooking based on recipe information acquired by the acquisition unit 131.

The estimation unit 132 estimates a specific factor that causes a change in the surrounding environment of the user. For example, the estimation unit 132 estimates a specific factor that gives a change to the surrounding environment of the user based on the recipe information. For example, the estimation unit 132 estimates a specific factor that can impair the comfort of the user's living space based on recipe information. For example, the estimation unit 132 estimates at least one specific factor of heat, wind, smell, or sound based on recipe information.

The estimation unit 132 estimates a cooking appliance that is an appliance used by the user for cooking. For example, the estimation unit 132 estimates the cooking appliance based on recipe information.

The estimation unit 132 estimates the degree of influence of a specific factor. For example, the estimation unit 132 estimates the degree of influence of the estimated specific factor. For example, the estimation unit 132 estimates the degree of influence of the estimated specific factor based on the arrangement information regarding the cooking appliance in the living space. For example, the estimation unit 132 estimates the degree of influence of the estimated specific factor based on the comfort of the user in the living space. Specifically, the estimation unit 132 estimates the degree of influence of the estimated specific factor based on the degree of comfort predefined by the user. Specifically, the estimation unit 132 estimates the degree of influence of the estimated specific factor based on log information of the degree of comfort routinely defined by the user.

The estimation unit 132 estimates a cooking process related to cooking based on recipe information.

(Determination Unit 133)

The determination unit 133 determines various types of information. The determination unit 133 determines various types of information from the storage unit 120. The determination unit 133 determines various types of information from the recipe information storage unit 121, the appliance information storage unit 122, and the living space information storage unit 123.

The determination unit 133 determines various types of information acquired, estimated, and judged by other functional configurations. Furthermore, the determination unit 133 determines various types of information based on various types of information acquired, estimated, and judged by other functional configurations.

The determination unit 133 determines an appliance being a control target. For example, the determination unit 133 determines a non-cooking appliance, which is an appliance that the user does not use for cooking, as an appliance being a control target. For example, the determination unit 133 determines the non-cooking appliance being a control target based on the recipe information.

The determination unit 133 determines the non-cooking appliance based on an estimation result obtained by estimation of the estimation unit 132. For example, the determination unit 133 determines the non-cooking appliance based on the specific factor estimated by the estimation unit 132. For example, the determination unit 133 determines the non-cooking appliance based on the cooking appliance estimated by the estimation unit 132. For example, the determination unit 133 determines, as a non-cooking appliance, an appliance predetermined as an appliance associated with the cooking appliance. For example, the determination unit 133 determines the non-cooking appliance associated with the cooking appliance to be the non-cooking appliance being a control target.

The determination unit 133 determines the non-cooking appliance being a control target based on the arrangement information regarding the cooking appliance. The determination unit 133 determines the non-cooking appliance being a control target based on the arrangement information regarding t the non-cooking appliance. The determination unit 133 determines the non-cooking appliance being a control target based on the arrangement information regarding t the cooking appliance and the arrangement information regarding the non-cooking appliance.

The determination unit 133 determines the non-cooking appliance being a control target based on the degree of the specific factor estimated by the estimation unit 132. The determination unit 133 determines the non-cooking appliance being a control target based on the degree of the specific factor estimated by the estimation unit 132, the arrangement information regarding the cooking appliance, and the arrangement information regarding the non-cooking appliance.

The determination unit 133 determines a non-cooking appliance being a control target based on an external environment that is an environment of a space external to the living space. For example, the determination unit 133 determines a non-cooking appliance being a control target based on a temperature difference between the living space and a space external to the living space. For example, the determination unit 133 determines a non-cooking appliance being a control target based on a weather condition in the space external to the living space.

Based on comfort information, which is information indicating the comfort of the living space predefined by the user, the determination unit 133 determines a non-cooking appliance being a control target based on a combination of a plurality of non-cooking appliances selected to satisfy the comfort information. For example, the determination unit 133 determines a non-cooking appliance being a control target based on a combination that achieves the lowest power consumption of the non-cooking appliance among a plurality of combinations of non-cooking appliances selected to satisfy the comfort information. For example, the determination unit 133 determines a non-cooking appliance being a control target based on a combination according to the user's preference for the external environment among a plurality of combinations of non-cooking appliances selected to satisfy the comfort information.

(Judgment Unit 134)

The judgment unit 134 judges various types of information. The judgment unit 134 judges various types of information from the storage unit 120. The judgment unit 134 judges various types of information from the recipe information storage unit 121, the appliance information storage unit 122, and the living space information storage unit 123.

The judgment unit 134 judges various types of information acquired, estimated, and determined by other functional configurations. Furthermore, the judgment unit 134 judges various types of information based on various types of information acquired, estimated, and determined by other functional configurations.

The judgment unit 134 judges the interest of the user. For example, the judgment unit 134 judges the interest of the user in the target provided by the non-cooking appliance. For example, the judgment unit 134 judges the interest of the user in the target provided by the non-cooking appliance based on the information regarding the user acquired by the acquisition unit 131 and sensor information.

The judgment unit 134 judges information regarding cooking performed by the user. For example, the judgment unit 134 judges whether the recipe is a recipe that the user desires to use for cooking. For example, the judgment unit 134 judges whether the recipe is a recipe selected by the user's intention. For example, the judgment unit 134 judges whether the recipe is a recipe that the user desires to use for cooking based on the information regarding the user acquired by the acquisition unit 131 or the sensor information.

(Appliance Control Unit 135)

The appliance control unit 135 controls various types of information. The appliance control unit 135 controls various types of information regarding appliances.

The appliance control unit 135 controls various types of information acquired, estimated, determined, and judged by other functional configurations. Furthermore, the appliance control unit 135 controls various types of information based on various types of information acquired, estimated, determined, and judged by other functional configurations.

The appliance control unit 135 controls the non-cooking appliance determined by the determination unit 133. For example, based on a predetermined condition, the appliance control unit 135 controls the non-cooking appliance determined by the determination unit 133. For example, at a timing before a predetermined process, the appliance control unit 135 controls the non-cooking appliance determined by the determination unit 133 based on a predetermined condition.

The appliance control unit 135 performs control before cooking performed by the user as the timing before a predetermined process. The appliance control unit 135 performs control before a predetermined cooking process in the cooking performed by the user as the timing before a predetermined process. The appliance control unit 135 performs control before taking a meal prepared by the cooking by the user as the timing before a predetermined process.

The appliance control unit 135 controls a cooking appliance.

The appliance control unit 135 performs processing related to notification to the user. For example, the appliance control unit 135 transmits information regarding notification to the user.

The appliance control unit 135 transmits control information for controlling the non-cooking appliance. The appliance control unit 135 transmits control information for controlling the cooking appliance.

### 5. Flow of Information Processing

Next, a procedure of information processing performed by the information processing system 1 according to the embodiment will be described with reference to FIG. 16. FIG. 16 is a flowchart illustrating a procedure of information processing performed by the information processing system 1 according to the embodiment.

As illustrated in FIG. 16, the information processing apparatus 100 judges whether a recipe to be used by the user for cooking has been determined (step S101). For example, the information processing apparatus 100 judges whether selection of a recipe by the user has been received. In a case where the recipe to be used by the user for cooking has not been determined (step S101; NO), the information processing apparatus 100 waits until determination of a recipe to be used by the user for cooking. In contrast, in a case where the recipe to be used by the user for cooking is determined (step S101; YES), the information processing apparatus 100 acquires recipe information corresponding to the determined recipe (step S102). The information processing apparatus 100 estimates the cooking appliance and the cooking process based on the acquired recipe information (step S103). Note that, in step S103, the information processing apparatus 100 may estimate the cooking process based on the acquired recipe information, and estimate the cooking appliance based on the estimated cooking process. Based on the estimated cooking appliance, the information processing apparatus 100 determines a non-cooking appliance being a control target (step S104). The information processing apparatus 100 estimates a degree of a specific factor that occurs during cooking based on the cooking process estimated in step S103 (step S105). Note that there is no limitation on the order of the processing in step S104 and step S105. That is, either step S104 or step S105 may be performed first, or both steps may be performed simultaneously. The information processing apparatus 100 controls the determined non-cooking appliance before a predetermined process according to the estimated degree of the specific factor (step S106).

### 6. Modifications

The information processing system 1 according to the embodiments described above may be implemented in various different forms other than the above-described embodiment. Therefore, other embodiments of the information processing system 1 will be described below. Note that description of points similar to those of the above embodiment will be omitted.

### 6-1. Utilization of Information Providing Device

Although the example described above is a case where the information processing apparatus 100 acquires information stored in the predetermined storage unit, the above embodiment is not limited to this example. For example, it is allowable to utilize an external information processing apparatus. Hereinafter, an external information processing apparatus that provides information to the information processing apparatus 100 is appropriately referred to as an information providing device 50. In this case, the information processing apparatus 100 may acquire information transmitted from the information providing device 50. For example, the information processing apparatus 100 may acquire all the information described above in the above embodiment from the information providing device 50. For example, the information processing apparatus 100 may acquire recipe information, appliance information, living space information and the like from the information providing device 50.

The above embodiment is a case where the information processing system 1 includes the sensor 10, the cooking appliance 20, the non-cooking appliance 30, and the information processing apparatus 100. However, the information processing system 1 may include the sensor 10, the cooking appliance 20, the non-cooking appliance 30, the information providing device 50, and the information processing apparatus 100.

### 6-2. Utilization of Projection Device

Although the example described above is an exemplary case where the information processing apparatus 100 performs notification via the terminal device of the user, the embodiment is not limited to this example. For example, a projection device having a projection function may be used. For example, a projection device such as a projector may be used. For example, it is allowable to use a projection device such as a projector that projects visual information. Hereinafter, a projection device having a projection function is appropriately referred to as a projection device 40. For example, the projection device 40 may be a projector. For example, the projection device 40 may be a projector that projects visual information having a drive function. For example, the projection device 40 may be a drive-type projection device. For example, the projection device 40 may be a projector equipped with a pan/tilt drive mechanism. In this case, the projection device 40 may perform projection onto a certain place by driving the projection device 40 itself. Furthermore, the projection device 40 may perform projection to a certain place by using reflection of a mirror having a pan-tilt drive mechanism. Furthermore, the projection device 40 may include a speaker that outputs voice or other sounds. In this case, the information processing apparatus 100 may notify the user via the projection device 40. For example, the information processing apparatus 100 may transmit information regarding notification to the user to the projection device 40. For example, the information processing apparatus 100 may transmit control information regarding notification to the user to the projection device 40. For example, the information processing apparatus 100 may perform notification to the user by projecting information regarding notification to the user as visual information via the projection device 40. For example, the information processing apparatus 100 may provide feedback regarding control of the non-cooking appliance and notify the current situation via the projection device 40.

### 6-3. First Modification of Information Processing System

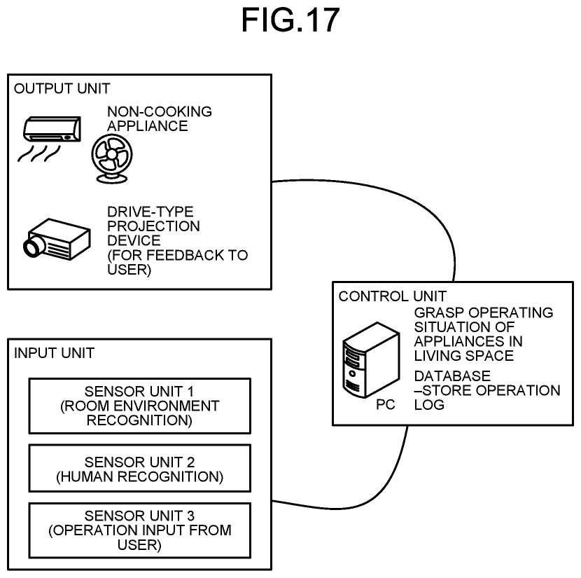

In the example described above, the sensor 10, the non-cooking appliance 30, the projection device 40, and the information processing apparatus 100 are separate devices. However, the sensor 10, the non-cooking appliance 30, the projection device 40, and the information processing apparatus 100 may be integrated to each other. FIG. 17 illustrates a configuration of the information processing system 1 in a case where the sensor 10, the non-cooking appliance 30, the projection device 40, and the information processing apparatus 100 are integrated to each other. In this case, the sensor 10 is referred to as an “input unit”. Furthermore, the information processing apparatus 100 is referred to as a “control unit”. In addition the non-cooking appliance 30 and the projection device 40 are referred to as an “output unit”.

### 6-4. Second Modification of Information Processing System

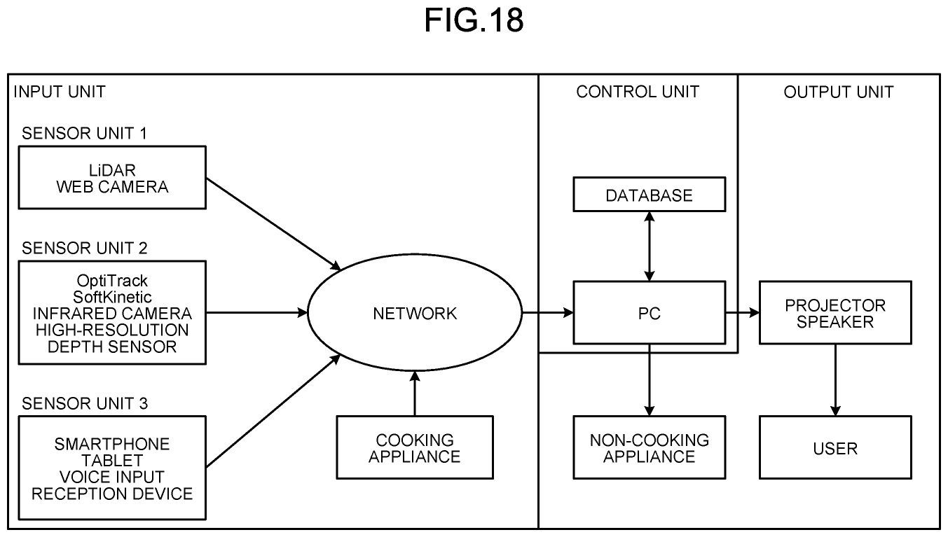

In the example described above, the sensor 10, the cooking appliance 20, the non-cooking appliance 30, the projection device 40, and the information processing apparatus 100 are separate devices. However, the sensor 10, the cooking appliance 20, the non-cooking appliance 30, the projection device 40, and the information processing apparatus 100 may be integrated to each other. FIG. 18 illustrates a configuration of the information processing system 1 in a case where the sensor 10, the cooking appliance 20, the non-cooking appliance 30, the projection device 40, and the information processing apparatus 100 are integrated to each other. In this case, the sensor 10 and the cooking appliance 20 are referred to as an “input unit”. Furthermore, the information processing apparatus 100 is referred to as a “control unit”. In addition the non-cooking appliance 30 and the projection device 40 are referred to as an “output unit”.

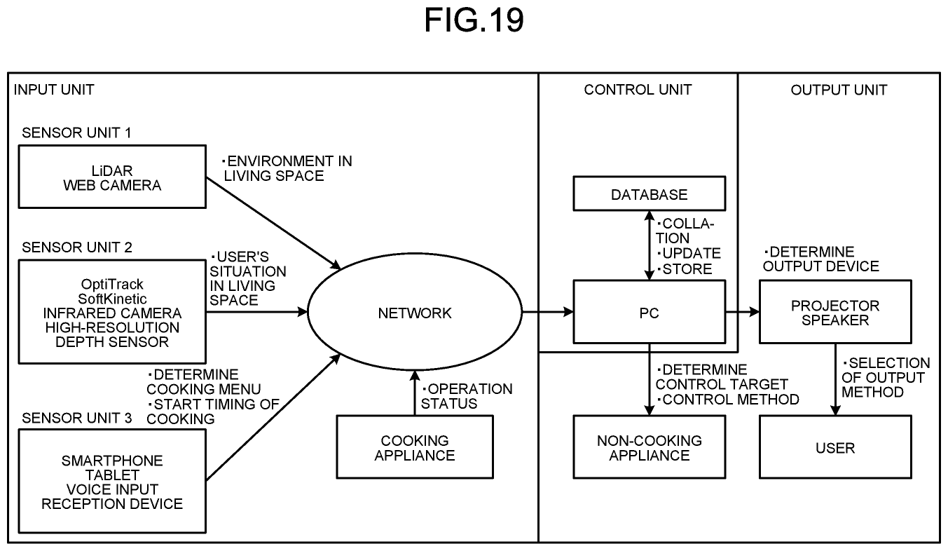

FIG. 19 illustrates information processing in each configuration illustrated in FIG. 18. For example, the sensor 10 transmits information regarding the environment in the living space via the network N. For example, the sensor 10 transmits information regarding the situation of the user in the living space via the network N. For example, the sensor 10 transmits information regarding determination of a recipe (cooking menu) and a timing of starting cooking via the network N. For example, the cooking appliance 20 transmits information regarding the operation status via the network N. For example, the information processing apparatus 100 performs processing related to collation, update, and storage of the acquired information. For example, the information processing apparatus 100 determines a non-cooking appliance being a control target. For example, the information processing apparatus 100 determines a method of controlling the non-cooking appliance being a control target. For example, the information processing apparatus 100 transmits control information to the non-cooking appliance being a control target. For example, the information processing apparatus 100 determines an output device. For example, the information processing apparatus 100 determines an output method. For example, the information processing apparatus 100 selects an output method. For example, the information processing apparatus 100 determines a user as an output destination. For example, the information processing apparatus 100 determines an output device to be used for notification to the user as the output destination.

### 7. Hardware Configuration

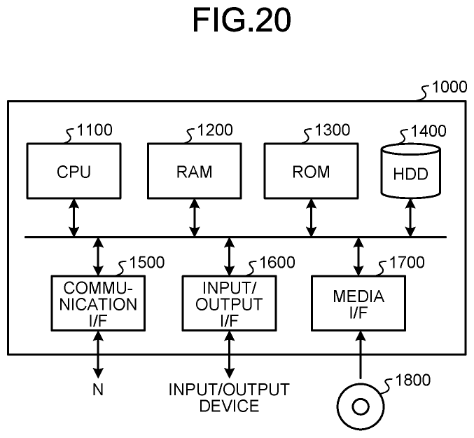

The sensor 10, the cooking appliance 20, the non-cooking appliance 30, the projection device 40, the information providing device 50, and the information processing apparatus 100 according to the above-described embodiment are implemented by a computer 1000 having a configuration as illustrated in FIG. 20. FIG. 20 is a hardware configuration diagram illustrating an example of a computer that implements the functions of the sensor 10, the cooking appliance 20, the non-cooking appliance 30, the projection device 40, the information providing device 50, and the information processing apparatus 100. The computer 1000 includes a CPU 1100, RAM 1200, ROM 1300, an HDD 1400, a communication interface (I/F) 1500, an input/output interface (I/F) 1600, and a media interface (I/F) 1700.

The CPU 1100 operates based on a program stored in the ROM 1300 or the HDD 1400 so as to control each of components. The ROM 1300 stores a boot program executed by the CPU 1100 at startup of the computer 1000, a program depending on hardware of the computer 1000, and the like.

The HDD 1400 stores a program executed by the CPU 1100, data used by the program, and the like. The communication interface 1500 receives data from another device via a predetermined communication network, transfers the data to the CPU 1100, and transmits data generated by the CPU 1100 to another device via a predetermined communication network.

The CPU 1100 controls an output device such as a display or a printer and an input device such as a keyboard or a mouse via the input/output interface 1600. The CPU 1100 acquires data from the input device via the input/output interface 1600. In addition, the CPU 1100 outputs the generated data to the output device via the input/output interface 1600.

The media interface 1700 reads a program or data stored in the recording medium 1800 and provides the program or data to the CPU 1100 via the RAM 1200. The CPU 1100 loads the program from the recording medium 1800 onto the RAM 1200 via the media interface 1700, and executes the loaded program. Examples of the recording medium 1800 include optical recording media such as a digital versatile disc (DVD) or a phase change rewritable disk (PD), a magneto-optical recording medium such as a magneto-optical disk (MO), a tape medium, a magnetic recording medium, or semiconductor memory.

For example, in a case where the computer 1000 functions as the sensor 10, the cooking appliance 20, the non-cooking appliance 30, the projection device 40, the information providing device 50, and the information processing apparatus 100 according to the embodiment, the CPU 1100 of the computer 1000 executes the program loaded on the RAM 1200 to implement the functions of a control unit 13 (control unit of the sensor 10), a control unit 23 (control unit of the cooking appliance 20), a control unit 33 (control unit of the non-cooking appliance 30), a control unit 43 (control unit of the projection device 40), a control unit 53 (control unit of the information providing device 50), and the control unit 130. Having read the programs from the recording medium 1800, the CPU 1100 of the computer 1000 executes the programs. However, as another example, these programs may be acquired from another device via a predetermined communication network.

### 8. Others

Furthermore, among each process described in the above embodiment and its modifications, all or a part of the processes described as being performed automatically may be manually performed, or the processes described as being performed manually can be performed automatically by a known method. In addition, the processing procedures, specific names, and information including various data and parameters illustrated in the above Literatures or drawings can be arbitrarily altered unless otherwise specified. For example, various types of information illustrated in each of the drawings are not limited to the information illustrated.

In addition, each of the components of each of the illustrated devices is provided as a functional and conceptional illustration and thus does not necessarily have to be physically configured as illustrated. That is, the specific mode of distribution/integration of each of devices is not limited to those illustrated in the drawings, and all or a part thereof may be functionally or physically distributed or integrated into arbitrary units according to various loads and use conditions.

Furthermore, the above-described embodiments and modifications can be appropriately combined within a range implementable without contradiction of processes.

While some of the embodiments of the present application have been described in detail with reference to the drawings, these are merely examples, and the present invention can be implemented in other forms subjected to various modifications and improvements based on the knowledge of those skilled in the art, including the aspects described in the disclosure of the invention.

In addition, the “part (section, module, or unit)” described above can be read as a word such as a “means” and “circuit”. For example, the acquisition unit can be read as an acquisition means or an acquisition circuit.

Note that the present technology can also have the following configurations.

(1)

An information processing apparatus including:

an acquisition unit that acquires recipe information, the recipe information being information regarding cooking performed by a user;

a determination unit that determines a non-cooking appliance, the non-cooking appliance being an appliance used by the user and not used for cooking, to be an appliance being a control target based on the recipe information acquired by the acquisition unit; and

an appliance control unit that controls the non-cooking appliance determined by the determination unit at a timing before a predetermined process based on a predetermined condition.

(2)

The information processing apparatus according to (1), further including an estimation unit that estimates the information regarding cooking based on the recipe information,

wherein the determination unit determines the non-cooking appliance based on a result of estimation obtained by the estimation unit.

(3)

The information processing apparatus according to (2),

wherein the estimation unit estimates a specific factor that gives a change to an environment around the user based on the information regarding cooking estimated based on the recipe information; and

the determination unit determines the non-cooking appliance based on the specific factor estimated by the estimation unit.

(4)

The information processing apparatus according to (3),

wherein the estimation unit estimates, as the specific factor, a specific factor that impairs comfort of a living space of the user.

(5)

The information processing apparatus according to (3) or (4),

wherein the estimation unit estimates, as the specific factor, at least one factor among heat, wind or smell, and sound.

(6)

The information processing apparatus according to any one of (3) to (5),

wherein the estimation unit estimates a cooking appliance, the cooking appliance being an appliance used for the cooking by the user, based on the information regarding cooking estimated based on the recipe information; and

the determination unit determines the non-cooking appliance based on the cooking appliance estimated by the estimation unit.

(7)

The information processing apparatus according to (6),

wherein the determination unit determining, as the non-cooking appliance, an appliance predetermined as an appliance associated with the cooking appliance.

(8)

The information processing apparatus according to (6) or (7),

wherein the acquisition unit acquires arrangement information regarding the cooking appliance in the living space and arrangement information regarding the non-cooking appliance in the living space; and

the determination unit determines the non-cooking appliance being a control target based on the arrangement information regarding the cooking appliance and the arrangement information regarding the non-cooking appliance, acquired by the acquisition unit.

(9)

The information processing apparatus according to any one of (3) to (8),

wherein the estimation unit estimates a degree of influence of the specific factor; and

the appliance control unit controls the non-cooking appliance based on the degree of influence of the specific factor estimated by the estimation unit.

(10)

The information processing apparatus according to (9),

wherein the estimation unit estimates the degree of influence of the specific factor based on the arrangement information regarding the cooking appliance in the living space; and

the determination unit determines the non-cooking appliance being a control target based on the degree of influence of the specific factor, the arrangement information regarding the cooking appliance, and the arrangement information regarding the non-cooking appliance.

(11)

The information processing apparatus according to (9) or (10),

wherein the estimation unit estimates the degree of influence of the specific factor based on the comfort of the user.

(12)

The information processing apparatus according to (11),

wherein the estimation unit estimates the degree of influence of the specific factor based on a degree of the comfort predefined by the user.

(13)

The information processing apparatus according to (11),

wherein the estimation unit estimates the degree of influence of the specific factor based on log information of the degree of comfort routinely determined by the user.

(14)

The information processing apparatus according to any one of (1) to (13),

wherein the determination unit determines the non-cooking appliance being a control target based on an external environment, the external environment being an environment of a space external to the living space of the user.

(15)

The information processing apparatus according to (14),

wherein the determination unit determines the non-cooking appliance being a control target based on a temperature difference between the living space of the user and the external space.

(16)

The information processing apparatus according to (14) or (15),

wherein the determination unit determines the non-cooking appliance being a control target based on a weather condition of the external space.

(17)

The information processing apparatus according to any one of (1) to (16),

wherein, based on comfort information, the comfort information being information indicating the comfort predefined by the user, the determination unit determines the non-cooking appliance being a control target based on a combination of a plurality of the non-cooking appliances selected to satisfy the comfort information.

(18)

The information processing apparatus according to (17),

wherein the determination unit determines the non-cooking appliance being a control target based on a combination that achieves a lowest power consumption of the non-cooking appliance among the plurality of combinations of non-cooking appliances selected to satisfy the comfort information.

(19)

The information processing apparatus according to (17) or (18)

wherein the determination unit determines the non-cooking appliance being a control target based on a combination according to a preference of the user toward the external environment among the plurality of combinations of non-cooking appliances selected to satisfy the comfort information.

(20)

The information processing apparatus according to any one of (1) to (19),

wherein the appliance control unit performs control before cooking performed by the user as the timing before a predetermined process.

(21)

The information processing apparatus according to any one of (1) to (20),

wherein the appliance control unit performs control before a predetermined cooking process in the cooking performed by the user as the timing before a predetermined process.

(22)

The information processing apparatus according to any one of (1) to (21),

wherein the appliance control unit performs control before taking a meal produced by the cooking by the user as the timing before a predetermined process.

(23)

An information processing method executed by a computer, the method including:

an acquisition process of acquiring recipe information, the recipe information being information regarding cooking performed by a user;

a determination process of determining a non-cooking appliance, the non-cooking appliance being an appliance used by the user and not used for cooking, to be an appliance being a control target based on the recipe information acquired by the acquisition process; and

an appliance control process of controlling the non-cooking appliance determined by the determination process at a timing before a predetermined process based on a predetermined condition.

(24)

An information processing program that causes a computer to execute procedures, the procedures including:

an acquisition procedure of acquiring recipe information, the recipe information being information regarding cooking performed by a user;

a determination procedure of determining a non-cooking appliance, the non-cooking appliance being an appliance used by the user and not used for cooking, to be an appliance being a control target based on the recipe information acquired by the acquisition procedure; and

an appliance control procedure of controlling the non-cooking appliance determined by the determination procedure at a timing before a predetermined process based on a predetermined condition.

### REFERENCE SIGNS LIST

1 INFORMATION PROCESSING SYSTEM
10 SENSOR
20 COOKING APPLIANCE
30 NON-COOKING APPLIANCE
40 PROJECTION DEVICE
50 INFORMATION PROVIDING DEVICE
100 INFORMATION PROCESSING APPARATUS
110 COMMUNICATION UNIT
120 STORAGE UNIT
121 RECIPE INFORMATION STORAGE UNIT
122 APPLIANCE INFORMATION STORAGE UNIT
123 LIVING SPACE INFORMATION STORAGE UNIT
130 CONTROL UNIT
131 ACQUISITION UNIT
132 ESTIMATION UNIT
133 DETERMINATION UNIT
134 JUDGMENT UNIT
135 APPLIANCE CONTROL UNIT
N NETWORK

1. An information processing apparatus including:
an acquisition unit that acquires recipe information, the recipe information being information regarding cooking performed by a user;
a determination unit that determines a non-cooking appliance, the non-cooking appliance being an appliance used by the user and not used for cooking, to be an appliance being a control target based on the recipe information acquired by the acquisition unit; and
an appliance control unit that controls the non-cooking appliance determined by the determination unit at a timing before a predetermined process based on a predetermined condition.

2. The information processing apparatus according to claim 1, further including an estimation unit that estimates the information regarding cooking based on the recipe information,
wherein the determination unit determines the non-cooking appliance based on a result of estimation obtained by the estimation unit.

3. The information processing apparatus according to claim 2,
wherein the estimation unit estimates a specific factor that gives a change to an environment around the user based on the information regarding cooking estimated based on the recipe information; and
the determination unit determines the non-cooking appliance based on the specific factor estimated by the estimation unit.

4. The information processing apparatus according to claim 3,
wherein the estimation unit estimates, as the specific factor, a specific factor that impairs comfort of a living space of the user.

5. The information processing apparatus according to claim 4,
wherein the estimation unit estimates, as the specific factor, at least one factor among heat, wind or smell, and sound.

6. The information processing apparatus according to claim 4,
wherein the estimation unit estimates a cooking appliance, the cooking appliance being an appliance used for the cooking by the user, based on the information regarding cooking estimated based on the recipe information; and
the determination unit determines the non-cooking appliance based on the cooking appliance estimated by the estimation unit.

7. The information processing apparatus according to claim 6,
wherein the determination unit determining, as the non-cooking appliance, an appliance predetermined as an appliance associated with the cooking appliance.

8. The information processing apparatus according to claim 7,
wherein the acquisition unit acquires arrangement information regarding the cooking appliance in the living space and arrangement information regarding the non-cooking appliance in the living space; and
the determination unit determines the non-cooking appliance being a control target based on the arrangement information regarding the cooking appliance and the arrangement information regarding the non-cooking appliance, acquired by the acquisition unit.

9. The information processing apparatus according to claim 8,
wherein the estimation unit estimates a degree of influence of the specific factor; and
the appliance control unit controls the non-cooking appliance based on the degree of influence of the specific factor estimated by the estimation unit.

10. The information processing apparatus according to claim 9,
wherein the estimation unit estimates the degree of influence of the specific factor based on the arrangement information regarding the cooking appliance in the living space; and
the determination unit determines the non-cooking appliance being a control target based on the degree of influence of the specific factor, the arrangement information regarding the cooking appliance, and the arrangement information regarding the non-cooking appliance.

11. The information processing apparatus according to claim 9,
wherein the estimation unit estimates the degree of influence of the specific factor based on the comfort of the user.

12. The information processing apparatus according to claim 11,
wherein the estimation unit estimates the degree of influence of the specific factor based on a degree of the comfort predefined by the user.

13. The information processing apparatus according to claim 11,
wherein the estimation unit estimates the degree of influence of the specific factor based on log information of the degree of comfort routinely determined by the user.

14. The information processing apparatus according to claim 11,
wherein the determination unit determines the non-cooking appliance being a control target based on an external environment, the external environment being an environment of a space external to the living space of the user.

15. The information processing apparatus according to claim 14,
wherein the determination unit determines the non-cooking appliance being a control target based on a temperature difference between the living space of the user and the external space.

16. The information processing apparatus according to claim 14,
wherein the determination unit determines the non-cooking appliance being a control target based on a weather condition of the external space.

17. The information processing apparatus according to claim 14,
wherein, based on comfort information, the comfort information being information indicating the comfort predefined by the user, the determination unit determines the non-cooking appliance being a control target based on a combination of a plurality of the non-cooking appliances selected to satisfy the comfort information.

18. The information processing apparatus according to claim 17,
wherein the determination unit determines the non-cooking appliance being a control target based on a combination that achieves a lowest power consumption of the non-cooking appliance among the plurality of combinations of non-cooking appliances selected to satisfy the comfort information.

19. The information processing apparatus according to claim 17,
wherein the determination unit determines the non-cooking appliance being a control target based on a combination according to a preference of the user toward the external environment among the plurality of combinations of non-cooking appliances selected to satisfy the comfort information.

20. The information processing apparatus according to claim 1,
wherein the appliance control unit performs control before cooking performed by the user as the timing before a predetermined process.

21. The information processing apparatus according to claim 1,
wherein the appliance control unit performs control before a predetermined cooking process in the cooking performed by the user as the timing before a predetermined process.

22. The information processing apparatus according to claim 1,
wherein the appliance control unit performs control before taking a meal produced by the cooking by the user as the timing before a predetermined process.

23. An information processing method executed by a computer, the method including:
an acquisition process of acquiring recipe information, the recipe information being information regarding cooking performed by a user;
a determination process of determining a non-cooking appliance, the non-cooking appliance being an appliance used by the user and not used for cooking, to be an appliance being a control target based on the recipe information acquired by the acquisition process; and
an appliance control process of controlling the non-cooking appliance determined by the determination process at a timing before a predetermined process based on a predetermined condition.

24. An information processing program that causes a computer to execute procedures, the procedures including:
an acquisition procedure of acquiring recipe information, the recipe information being information regarding cooking performed by a user;
a determination procedure of determining a non-cooking appliance, the non-cooking appliance being an appliance used by the user and not used for cooking, to be an appliance being a control target based on the recipe information acquired by the acquisition procedure; and
an appliance control procedure of controlling the non-cooking appliance determined by the determination procedure at a timing before a predetermined process based on a predetermined condition.
